(19) United States
(12) Patent Application Publication
(10) Pub. No.: US 2002/0091722 A1
(43) Pub. Date: Jul. 11, 2002

(54) Systems and methods for resource management in information storage environments

(75) Inventors: Umesh Gupta, Austin, TX (US); Scott C. Johnson, Round Rock, TX (US); Sarma Kolavasi, Austin, TX (US); Chaoxin C. Qiu, Austin, TX (US); Theodore S. Webb, Austin, TX (US); Richard W. Yu, Cedar Park, TX (US); Mark J. Conrad, Colorado Springs, CO (US)

Correspondence Address: William W. Enders, O'KEEFE, EGAN & PETERMAN, Building C, Suite 200, 1101 Capital of Texas Highway South, Austin, TX, 78746, US

(73) Assignee: SURGIENT NETWORKS, INC.

(21) Appl. No.: 09/970,457

(22) Filed: Oct. 3, 2001

Related U.S. Application Data
(63) Continuation of application No. 09/947,869, filed on Sep. 6, 2001.
(60) Provisional application No. 60/285,211, filed on Apr. 20, 2001.
(60) Provisional application No. 60/291,073, filed on May 15, 2001.
(60) Provisional application No. 60/246,445, filed on Nov. 7, 2000.
(60) Provisional application No. 60/246,359, filed on Nov. 7, 2000.
(60) Provisional application No. 60/187,211, filed on Mar. 3, 2000.
(60) Provisional application No. 60/246,401, filed on Nov. 7, 2000.

(51) Int. Cl. G06F 12/00

(52) U.S. Cl. 707/204

(57) ABSTRACT

Methods and systems for I/O resource management that may be employed to manage information management system I/O resources based on modeled and/or monitored I/O resource information, and that may be implemented to optimize information management system I/O resources for the delivery of a variety of data object types, including continuous streaming media data files. The methods and systems may be implemented in an adaptive manner that is capable of optimizing information management system I/O performance by dynamically adjusting information management system I/O operational parameters to meet changing requirements or demands of a dynamic application or information management system I/O environment using a resource management architecture. The resource management architecture may include, for example, a resource manager, a resource model, a storage device workload monitor and/or a storage device capacity monitor. The resource model may be configured to generate system performance information based on monitored storage device workload and/or storage device capacity information. The resource manager may be configured to manage information management system I/O operation and/or resources using the system performance information.

This application claims priority from co-pending U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS,” and also claims priority from co-pending Provisional Application Ser. No. 60/285,211 filed on Apr. 20, 2001 which is entitled “SYSTEMS AND METHODS FOR PROVIDING DIFFERENTIATED SERVICE IN A NETWORK ENVIRONMENT,” and also claims priority from co-pending Provisional Application Ser. No. 60/291,073 filed on May 15, 2001 which is entitled “SYSTEMS AND METHODS FOR PROVIDING DIFFERENTIATED SERVICE IN A NETWORK ENVIRONMENT,” the disclosures of each of the forgoing applications being incorporated herein by reference. This application also claims priority from co-pending U.S. patent application Ser. No. 09/797,198 filed on Mar. 1, 2001 which is entitled “SYSTEMS AND METHODS FOR MANAGEMENT OF MEMORY,” and also claims priority from co-pending U.S. patent application Ser. No. 09/797,201 filed on Mar. 1, 2001 which is entitled “SYSTEMS AND METHODS FOR MANAGEMENT OF MEMORY IN INFORMATION DELIVERY ENVIRONMENTS,” and also claims priority from co-pending Provisional Application Ser. No. 60/246,445 filed on Nov. 7, 2000 which is entitled “SYSTEMS AND METHODS FOR PROVIDING EFFICIENT USE OF MEMORY FOR NETWORK SYSTEMS,” and also claims priority from co-pending Provisional Application Ser. No. 60/246,359 filed on Nov. 7, 2000 which is entitled “CACHING ALGORITHM FOR MULTIMEDIA SERVERS,” the disclosures of each of the forgoing applications being incorporated herein by reference. This application also claims priority from co-pending U.S. patent application Ser. No. 09/797,200 filed on Mar. 1, 2001 which is entitled “SYSTEMS AND METHODS FOR THE DETERMINISTIC MANAGEMENT OF INFORMATION” which itself claims priority from Provisional Application Ser. No. 60/187,211 filed on Mar. 3, 2000 which is entitled “SYSTEM AND APPARATUS FOR INCREASING FILE SERVER BANDWIDTH,” the disclosures of each of the forgoing applications being incorporated herein by reference. This application also claims priority from co-pending Provisional Application Ser. No. 60/246,401 filed on Nov. 7, 2000 which is entitled “SYSTEM AND METHOD FOR THE DETERMINISTIC DELIVERY OF DATA AND SERVICES,” the disclosure of which is incorporated herein by reference.

### BACKGROUND OF THE INVENTION

The present invention relates generally to information management, and more particularly, to resource management in information delivery environments.

In information system environments, files are typically stored by external large capacity storage devices, such as storage disks of a storage area network (“SAN”). To access or “fetch” data stored on a conventional storage disk typically requires a seek operation during which a read head is moved to the appropriate cylinder, a rotate operation during which the disk is rotated to position the read head at the beginning of desired sectors, and a transfer operation during which data is read from the disk and transferred to storage processor memory. Time is required to complete each of these operations, and the delay in accessing or fetching data from storage is equal to the sum of the respective times required to complete each of the seek, rotate and transfer operations. This total delay encountered to fetch data from a storage device for each input/output operation (“I/O”), e.g., each read request, may be referred to as “response time.” “Service time” refers to a logical value representing the total time interval during which a request for information or data is receiving service from a resource such as a processor, CPU or storage device.

With most modern disk storage devices, the time required for data transfer to memory is typically smaller than the delay encountered when completing seek and rotate operations. Due to the large number of files typically stored on modern disk storage devices, the time required to fetch a particular file from storage media to storage processor memory is often a relatively time consuming process compared to the time required to transmit or send the file from memory on to other network devices. In the case of delivery of continuous streaming content (e.g., delivery of large streaming multimedia video/audio files), service time is often particularly significant due to the large number of I/O (e.g., read request) operations associated with such continuous files. For the delivery of such streaming files, it is particularly desirable to optimize system throughput performance and to provide quality control for delivered content.

In the past, efforts have been made to improve storage system performance and overcome the capacity gap between the main memory and storage devices. For example, caching designs have been formulated in an attempt to re-use fetched data effectively so as to reduce the workload of the storage system. Batch scheduling efforts have focused on attempts to use less storage resources to serve a maximum number of client requests. However, caching and batch scheduling techniques do not directly address storage device behavior. Also considered have been data placement techniques that attempt to reduce seek time by placing data according to its access pattern, including both single disk block placement techniques and multi-disk file placement techniques.

Other efforts at enhancing system performance have been directed towards performance disk arm I/O scheduling. Disk arm I/O scheduling relates to knowledge of physical data location and I/O request priority/dead-lines. Examples of conventional disk arm I/O scheduling techniques include round-based scheduling such as round-robin (i.e., first-come-first-serve), “SCAN” (i.e., moving disk arm from the edge to the center and back), Group Sweeping Scheduling (“GSS”) (i.e., partitioned SCAN), and fixed transfer size scheduling such as SCAN Earliest Deadline First (“SCAN-EDF”) (i.e., deadline aware SCAN).

Prefetching techniques implemented at both host and drive levels have also been proposed in an attempt to enhance system performance. In this regard, storage level prefetching relates to attempts to improve efficiency of storage resource use, and application level prefetching relates to attempts to smooth variable-bit-rate traffic in multimedia applications. Aggressive prefetching may also include buffer sharing techniques to maximize the performance improvement.

When continuous content serving requirements exceed capability of storage resources and/or buffer memory capacity, viewers may experience “hiccups” or disruptions in the continuity of data flow. Thus, in an effort to provide quality control for delivered content, attempts have been made to compare estimated data fetch times with estimated data send times to ensure that sufficient storage resources (e.g., I/O operations per second) exist to fetch data in a period of time that is less than the period of time required to send the data to viewers in a timely manner. Such estimates may also be employed to ensure that sufficient storage processor memory (e.g., buffer memory) exists to support the viewers. Such calculations have been employed to make decisions on whether or not new viewers may be admitted without adversely affecting delivery of content to existing viewers. In the past, such calculations have typically assumed conditions of static bit rate, constant data block size, and known number of viewers i.e., by assuming a known number of streams and known service time required per stream.

Yet other attempts have been made to improve continuous content delivery by optimizing fetched block size. Techniques of this type include constant data length (“CDL”) and constant time length (“CTL”) methods. CDL methods fetch data blocks of constant size and have typically been employed for use in relatively homogenous content serving environments, or environments where demand for I/O operations is relatively constant, such as local area network (“LAN”) environments. CTL methods fetch data using a fixed time interval rather than fixed data block size, so that fetched block size varies depending on instantaneous data transfer rate. CTL methods are typically employed for more heterogeneous content serving environments, or those environments where stream rates are variable, such as is often encountered in wide area network (“WAN”) environments such as the Internet. However, it is often difficult to accurately estimate or measure data fetch times, especially for dynamically changing fetched block size schemes such as employed in CTL data fetching methods. Further, because CTL data fetching methods employ variable fetched block sizes it is also difficult to estimate memory requirements. Rapidly changing viewer identity and varying stream rates associated therewith further compromise the usefulness of such static-based calculations.

One example of past efforts at enhancing content delivery quality are methods directed towards admission control policies designed to support various scheduling algorithms. Examples of such admission control policies include a minimal buffer allocation algorithm used in a Continuous Media File System (“CMFS”), and a Quality Proportional Multi-subscriber (“QPMS”) buffer allocation algorithm. Using the minimal buffer allocation algorithm, each data stream is assigned a minimal but sufficient buffer share for its read-ahead segment size in an attempt to ensure continuous playback. Using QPMS, the available buffer space is partitioned among existing data streams. However, both the minimal buffer allocation algorithm and the QPMS buffer allocation algorithm suffer from disadvantages. The minimal buffer allocation algorithm tends to generate an imbalance between storage load and memory consumption and requires re-calculation every time a new stream is introduced. The QPMS buffer allocation algorithm works to maximize memory consumption and also tends to generate an imbalance between memory and storage utilization. Thus, neither of these admission control policies perform well dynamically when various data streams are being added and removed.

### SUMMARY OF THE INVENTION

Disclosed herein are methods and systems for I/O resource management that may be employed in an information delivery environment to manage I/O resources based on modeled and/or monitored I/O resource information, and that may be implemented in a manner that serves to optimize given information management system I/O resources, e.g., file system I/O subsystem resources, storage system I/O resources, etc. The disclosed methods and systems may be advantageously implemented in the delivery of a variety of data object types including, but not limited to, over-size data objects such as continuous streaming media data files and very large non-continuous data files, and may be employed in such environments as streaming multimedia servers or web proxy caching for streaming multimedia files. Also disclosed are I/O resource management algorithms that are effective, high performance and which have low operational cost so that they may be implemented in a variety of information management system environments, including high-end streaming servers.

Using the disclosed algorithms, buffer, cache and free pool memory may be managed together in an integrated fashion and used more effectively to improve system throughput. The disclosed memory management algorithms may also be employed to offer better streaming cache performance in terms of total number of streams a system can support, improvement in streaming system throughput, and better streaming quality in terms of reducing or substantially eliminating hiccups encountered during active streaming.

Advantageously, the disclosed methods and systems may be implemented in an adaptive manner that is capable of optimizing information management system I/O performance by, for example, dynamically adjusting system I/O operational parameters to meet changing requirements or demands of a dynamic application or information management system I/O environment, such as may be encountered in the delivery of continuous content (e.g. such as streaming video-on-demand or streaming Internet content), delivery of non-continuous content (e.g., such as encountered in dynamic FTP environments), etc. This adaptive behavior may be exploited to provide better I/O throughput for an I/O subsystem by balancing resource utilization, and/or to provide better quality of service (“QoS”) control for I/O subsystems. Thus, the disclosed methods and systems may be implemented to provide an application-aware I/O subsystem that is capable of high performance information delivery (i.e., in terms of both quality and throughput), but that need not be tied to any specific application.

Further advantageously, the disclosed methods and systems may be deployed in scenarios (e.g., streaming applications) that utilize non-mirrored disk configurations. When deployed in such non-mirrored environments, the disclosed methods and systems may be implemented to provide an understanding of the workload on each disk drive, and to leverage the knowledge of workload distribution in the I/O admission control algorithm.

In certain embodiments, the disclosed methods and systems may be employed so as to take advantage of relaxed or relieved QoS backend deadlines made possible when client side buffering technology is present in an information delivery environment. In certain other embodiments, the disclosed systems and methods may be additionally or alternatively employed in a manner that adapts to changing information management demands and/or that adapts to variable bit rate environments encountered, for example, in an information management system simultaneously handling or delivering content of different types (e.g., relatively lower bit rate delivery employed for newscasts/talk shows, simultaneously with relatively higher bit rate delivery employed for high action theatrical movies). The capabilities of exploiting relaxed/relieved backend deadlines and/or adapting to changing conditions/requirements of an information delivery environment allows the disclosed methods and systems to be implemented in a manner that provides enhanced performance over conventional storage system designs not possessing these capabilities.

In one respect then, disclosed herein is a resource model that takes into account I/O resources such as disk drive capacity and/or memory availability. The resource model may be capable of estimating information management system I/O resource utilization. The resource model may also be used, for example, by a resource manager to make decisions on whether or not a system is capable of supporting additional clients or viewers, and/or to adaptively change read-ahead strategy so that system resource utilization may be balanced and/or optimized. The resource model may be further capable of discovering a limitation on read-ahead buffer size under exceptional conditions, e.g., when client access pattern is highly skewed. A limit or cap on read-ahead buffer size may be further incorporated so that buffer memory resource may be better utilized. In one embodiment, the resource model may incorporate an algorithm that considers system design and implementation factors in a manner so that the algorithm is capable of yielding results that reflect actual system dynamics.

In another respect, disclosed herein is a resource model that may be used, for example, by a resource manager, to modify the cycle time of one or more storage devices of an unequally-loaded multiple storage device system in order to better allocate buffer space among unequally-loaded storage devices (e.g., multiple storage devices containing content of different popularity levels). In this regard, read-ahead may become unequal when disk access pattern (i.e., workload) is unequal. This capability may be implemented, for example, to lower the cycle time of a lightly-loaded disk drive (e.g., containing relatively less popular content) so that the lightly-loaded disk drive uses more input output operations per second (“IOPS”), and consumes less buffer space, thus freeing up more buffer space for use by cache memory and/or for access use by a more heavily-loaded disk drive (e.g., containing relatively more popular content) of the same system. The resource model may also be capable of adjusting cache memory size to optimize system performance, e.g., by increasing cache memory size rather than buffer memory size in those cases where increasing buffer size will result in no throughput improvement.

In yet another respect, disclosed herein is a disk workload monitor that is capable of dynamically monitoring or tracking disk access load at the logical volume level. The disk workload monitor may be capable of feeding or otherwise communicating the monitored disk access load information back to a resource model.

In yet another respect, disclosed is a disk capacity monitor that is capable of dynamically monitoring or measuring disk drive capacity. The disk capacity monitor may be capable of feeding or otherwise communicating the monitored disk drive capacity information back to a resource model.

In yet another respect, disclosed herein is a storage management processing engine that is capable of monitoring system I/O resource workload distribution and/or of detecting workload skew. The monitored workload distribution and/or workload skew information may be fed back or otherwise communicated to an I/O manager or I/O admission controller (e.g., I/O admission control algorithm running in a resource manager of the storage processing engine), and may be taken into account or otherwise considered when making decisions regarding the admission of new requests for information (e.g., requests for streaming content). The disclosed methods and systems may include storage management processing engine software designed for implementation in a resource manager and/or logical volume manager of the storage management processing engine.

In yet another respect, disclosed herein is a resource management architecture that may include a resource manager, a resource model, a disk workload monitor and/or a disk capacity monitor. The resource manager and/or resource model may be in communication with at least one of the resource manager, resource model, or a combination thereof. In operation, monitored workload and/or disk capacity information may be dynamically fed back directly to the resource model or indirectly to the resource model through the resource manager. The resource model may be used by the resource manager to generate system performance information, such as system utilization information, based on the monitored workload and/or storage device capacity information. The resource manager may be configured to use the generated system performance information to perform admission control (e.g., so that the resource manager effectively monitors workload distribution among all storage devices under its control and uses this information for I/O admission control for the information management system) and/or to advise or instruct the information management system regarding read-ahead strategy.

In one embodiment, the disclosed resource management architecture may be employed to manage delivery of information from storage devices that are capable of performing resource management and I/O demand scheduling at the logical volume level. In this embodiment, read-ahead size or length may be estimated based on designated I/O capacity and buffer memory size, and the method may be used as an admission control policy when accepting new I/O demands at the logical volume level. In one implementation, this embodiment of the disclosed method may be employed to decision whether or not there is enough I/O capacity and buffer memory to support a new viewer's demand for a video object (e.g. a movie), and if so, what is the optimal read-ahead size for each viewer that is served by I/O operations based on the available I/O capacity, the buffer memory size, and information related to characteristics of the existing viewers.

In yet another respect, disclosed herein are substantially lightweight or low-processing-overhead methods and systems that may be implemented to support Internet streaming (e.g., including video-on-demand (“VOD”) applications). These disclosed methods and systems may utilize workload monitoring algorithms implemented in the storage processor, may further include and consider workload distribution information in I/O admission control calculations/decisions, and/or may further include a lightweight IOPS validation algorithm that may be used to verify system I/O performance characteristics such as “average access time” and “transfer rate” when a system is turned on or rebooted.

In yet another respect, disclosed herein is a network processing system operable to process information communicated via a network environment. The system may include a network processor operable to process network-communicated information and a storage management processing engine operable to perform the I/O resource management features described herein.

In yet another respect, disclosed is a method of managing I/O resources in an information delivery environment, including modeling utilization of at least one of the I/O resources; and managing at least one of the I/O resources based at least in part on the modeled utilization.

In yet another respect, disclosed is a method of managing I/O resources for delivery of continuous media data to a plurality of viewers from a storage system including at least one storage device or at least one partitioned group of storage devices, the method including modeling utilization of at least one of the I/O resources; and managing at least one of the I/O resources based at least in part on the modeled utilization.

In yet another respect, disclosed is a method of managing I/O resources in an information delivery environment, including performing admission control and determining read-ahead size for a storage system based at least in part on modeled utilization of at least one I/O resources of the storage system.

In yet another respect, disclosed is a method of modeling utilization of one or more I/O resources in an information delivery environment, including monitoring at least one of the system I/O performance characteristics associated with the I/O resources, and modeling utilization of at least one of the I/O resources based at least in part on the monitored I/O system performance characteristics.

In yet another respect, disclosed is a method of monitoring I/O resource utilization in an information delivery environment, including monitoring the I/O resource utilization at the logical volume level.

In yet another respect, disclosed is a method of monitoring I/O resource utilization for delivery of information to a plurality of viewers from an information management system including storage system I/O resources and at least one storage device or at least one partitioned group of storage devices; the method including logically monitoring workload of the at least one storage device or at least one partitioned group of storage devices.

In yet another respect, disclosed is an I/O resource management system capable of managing I/O resources in an information delivery environment, including: an I/O resource model capable of modeling utilization of at least one of the I/O resources; and an I/O resource manager in communication with the I/O resource model, the I/O resource manager being capable of managing at least one of the I/O resources based at least in part on the modeled utilization.

In yet another respect, disclosed is an I/O resource management system capable of managing I/O resources for delivery of continuous media data to a plurality of viewers from a storage system including at least one storage device or at least one partitioned group of storage devices, the system including: an I/O resource monitor, the I/O resource monitor being capable of monitoring at least one of the system I/O performance characteristics associated with the I/O resources; an I/O resource model in communication with the I/O resource monitor, the resource model being capable of modeling utilization of at least one of the I/O resources based at least in part on the at least one of the monitored system I/O performance characteristics; and an I/O resource manager in communication with the I/O resource model, the I/O resource manager being capable of managing at least one of the I/O resources based at least in part on the modeled utilization.

In yet another respect, disclosed is an information delivery storage system, the storage system including: a storage management processing engine that includes an I/O resource manager, a logical volume manager, and a monitoring agent; the I/O resource manager, the logical volume manager, and the monitoring agent being in communication; and at least one storage device or group of storage devices coupled to the storage management processing engine; wherein the information delivery storage system includes part of an information management system configured to be coupled to a network.

### BRIEF DESCRIPTION OF THE DRAWINGS

FIG. 1 is a simplified representation of a storage system including a storage management processing engine coupled to storage devices according to one embodiment of the disclosed methods and systems.

FIG. 2 is a graphical representation of buffer allocation and disposition versus time for a sliding window buffer approach using two buffers according to one embodiment of the disclosed methods and systems.

FIG. 3A illustrates deterministic I/O resource management according to one embodiment of the disclosed methods and systems.

FIG. 3B illustrates deterministic I/O resource management according to another embodiment of the disclosed methods and systems.

FIG. 4A is a simplified representation of a storage system including a storage processor capable of monitoring workload of storage devices coupled to the storage system according to one embodiment of the disclosed methods and systems.

FIG. 4B is a simplified representation of a storage system having multiple storage devices that are allocated portions of buffer memory according to one embodiment of the disclosed methods and systems.

FIG. 5 illustrates lower and upper bounds of cycle time T plotted as a function of total number of viewers NoV according to one embodiment of the disclosed methods and systems.

FIG. 6 illustrates lower and upper bounds of cycle time T plotted as a function of total number of viewers NoV according to one embodiment of the disclosed methods and systems.

FIG. 7 illustrates lower and upper bounds of cycle time T plotted as a function of total number of viewers NoV according to one embodiment of the disclosed methods and systems.

### DESCRIPTION OF ILLUSTRATIVE EMBODIMENTS

Disclosed herein are methods and systems for managing information management system I/O resources (e.g., file system resources, storage system resources, etc.) in information delivery environments. The disclosed methods and systems may be configured to employ unique resource modeling and/or resource monitoring techniques and may be advantageously implemented in a variety of information delivery environments and/or with a variety of types of information management systems. Examples of just a few of the many types of information delivery environments and/or information management system configurations with which the disclosed methods and systems may be advantageously employed are described in co-pending U.S. patent application Ser. No. 09/797,413 filed on Mar. 1, 2001 which is entitled NETWORK CONNECTED COMPUTING SYSTEM; in co-pending U.S. patent application Ser. No. 09/797,200 filed on Mar. 1, 2001 which is entitled SYSTEMS AND METHODS FOR THE DETERMINISTIC MANAGEMENT OF INFORMATION; and in co-pending U.S. patent application Ser. No. 09/879,810 filed on Jun. 12, 2001 which is entitled SYSTEMS AND METHODS FOR PROVIDING DIFFERENTIATED SERVICE IN INFORMATION MANAGEMENT ENVIRONMENTS; each of the foregoing applications being incorporated herein by reference.

Included among the examples of information management systems with which the disclosed methods and systems may be implemented are network content delivery systems that deliver non-continuous content (e.g., HTTP, etc.), continuous streaming content (e.g., streaming video, streaming audio, web proxy cache for Internet streaming, etc.) and/or that deliver over-size or very large data objects of any other kind, such as over-size non-continuous data objects. As used herein an “over-size data object” refers to a data object that has an object size that is so large relative to the available buffer/cache memory size of a given information management system, that caching of the entire data object is not possible or is not allowed by policy within the given system. Examples of non-continuous over-size data objects include, but are not limited to, relatively large FTP files, etc.

By monitoring resource consumption and availability (e.g., disk workload, logical volume workload, disk capacity, etc.) resource characteristics may be modeled and used to make admission control decisions and to define read-ahead strategy. Dynamic resource monitoring may be further implemented to enable dynamic and/or adaptive I/O resource management, for example, to make admission control decisions and/or adjust read-ahead strategy as desired or needed based on changing characteristics of resource consumption/availability characteristics. Such an adaptive approach to I/O resource modeling and management makes possible enhanced system I/O performance to fit a variety of changing information management system I/O conditions. In one exemplary embodiment, dynamic measurement-based I/O admission control may be enabled by monitoring the workload and the storage device utilization constantly during system run-time, and accepting or rejecting new I/O requests based on the run-time knowledge of the workload. In this regard, workload may be expressed herein in terms of outstanding I/O's or read requests.

The disclosed methods and systems may be implemented to manage memory units stored in any type of memory storage device or group of such devices suitable for providing storage and access to such memory units by, for example, a network, one or more processing engines or modules, storage and I/O subsystems in a file server, etc. Examples of suitable memory storage devices include, but are not limited to random access memory (“RAM”), disk storage, I/O subsystem, file system, operating system or combinations thereof. Memory units may be organized and referenced within a given memory storage device or group of such devices using any method suitable for organizing and managing memory units. For example, a memory identifier, such as a pointer or index, may be associated with a memory unit and “mapped” to the particular physical memory location in the storage device (e.g. first node of Q₁^{used}=location FF00 in physical memory). In such an embodiment, a memory identifier of a particular memory unit may be assigned/reassigned within and between various layer and queue locations without actually changing the physical location of the memory unit in the storage media or device. Further, memory units, or portions thereof, may be located in non-contiguous areas of the storage memory. However, it will be understood that in other embodiments memory management techniques that use contiguous areas of storage memory and/or that employ physical movement of memory units between locations in a storage device or group of such devices may also be employed.

Partitioned groups of storage devices may be present, for example, in embodiments where resources (e.g., multiple storage devices, buffer memory, etc.) are partitioned into groups on the basis of one or more characteristics of the resources (e.g., on basis of physical drives, on basis of logical volume, on basis of multiple tenants, etc.). In one such embodiment, storage device resources may be associated with buffer memory and/or other resources of a given resource group according to a particular resource characteristic, such as one or more of those characteristics just described.

Although described herein in relation to block level memory, it will be understood that embodiments of the disclosed methods and system may be implemented to manage memory units on virtually any memory level scale including, but not limited to, file level units, bytes, bits, sector, segment of a file, etc. However, management of memory on a block level basis instead of a file level basis may present advantages for particular memory management applications, by reducing the computational complexity that may be incurred when manipulating relatively large files and files of varying size. In addition, block level management may facilitate a more uniform approach to the simultaneous management of files of differing type such as HTTP/FTP and video streaming files.

The disclosed methods and systems may be implemented in combination with any memory management method, system or structure suitable for logically or physically organizing and/or managing memory, including integrated logical memory management structures such as those described in U.S. patent application Ser. No. 09/797,198 filed on Mar. 1, 2001 which is entitled SYSTEMS AND METHODS FOR MANAGEMENT OF MEMORY; and in U.S. patent application Ser. No. 09/797,201 filed on Mar. 1, 2001 which is entitled SYSTEMS AND METHODS FOR MANAGEMENT OF MEMORY IN INFORMATION DELIVERY ENVIRONMENTS, each of which is incorporated herein by reference. Such integrated logical memory management structures may include, for example, at least two layers of a configurable number of multiple memory queues (e.g., at least one buffer layer and at least one cache layer), and may also employ a multi-dimensional positioning algorithm for memory units in the memory that may be used to reflect the relative priorities of a memory unit in the memory, for example, in terms of both recency and frequency. Memory-related parameters that may be may be considered in the operation of such logical management structures include any parameter that at least partially characterizes one or more aspects of a particular memory unit including, but are not limited to, parameters such as recency, frequency, aging time, sitting time, size, fetch (cost), operator-assigned priority keys, status of active connections or requests for a memory unit, etc.

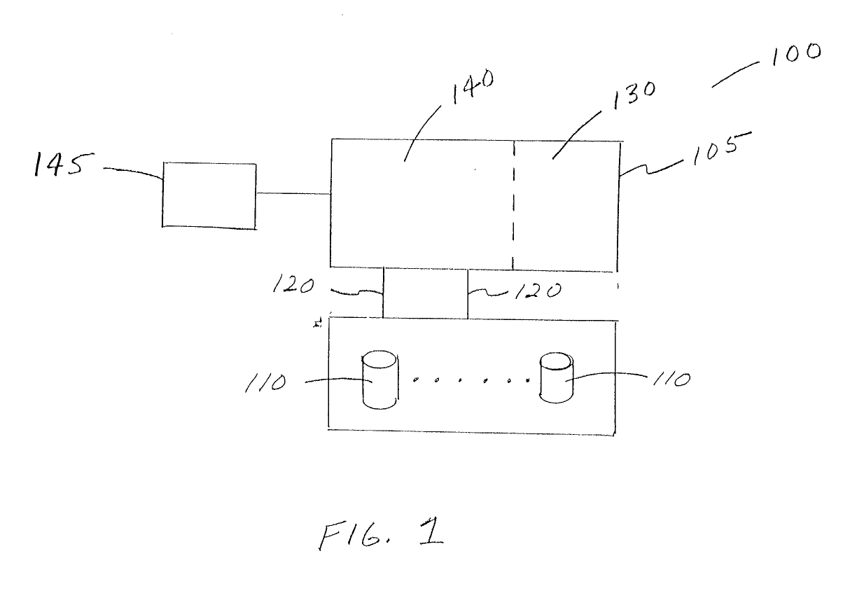

FIG. 1 is a simplified representation of one embodiment of a storage system 100 including a storage management processing engine 105 coupled to storage devices 110 using, for example, fiber channel loop 120 or any other suitable interconnection technology. In the illustrated embodiment, storage devices 110 may include a plurality of storage media, for example, a group of storage disks provided in a JBOD configuration. However, it will be understood that storage devices 110 may include any other type, or combination of types, of storage devices including, but not limited to, magnetic disk, optical disk, laser disk, etc. It is also possible that multiple groups of storage devices may be coupled to storage management processing engine 105. Further, it will be understood that although storage system embodiments are illustrated herein, that benefits of the disclosed methods and systems may be realized in any information management system I/O resource environment including, but not limited to, storage system environments, file system environments, etc.

As shown in FIG. 1, storage management processing engine 105 may include an I/O manager 140 that may receive requests, e.g., from a file subsystem, for information or data contained in storage devices 110. I/O manager 140 may be provided with access to I/O characteristic information, for example, in the form of an I/O capacity data table 145 that includes such information as the estimated average access delay and the average transfer rate per storage device type, storage device manufacturer, fiber channel topology, block size, etc. In one exemplary embodiment, I/O manager 140 and an I/O capacity data table 145 may be combined as part of a storage sub-processor resource manager. Storage management processing engine 105 may also include a cache/buffer manager 130 that monitors or is otherwise aware of available buffer memory in storage system 100.

In the illustrated embodiment, I/O manager 140 may be configured to be capable of monitoring or tracking one or more system I/O performance characteristics of an information management system including, but not limited to, average access delay (“AA”), average transfer rate (“TR”) from the storage device(s) to the I/O controller, total number of viewers (“NoV”) each presenting an I/O request for a continuous portion of an information object such as a multimedia object, consumption rate (“P”) of one or more viewers in the I/O queue, the maximal available buffer memory (“Bₘₐₓ”), combinations thereof, etc.

In one exemplary implementation of the embodiment of FIG. 1, storage devices 110 may be JBOD disks provided for delivering continuous content such as streaming video. In this implementation, I/O manager 140 may be configured to have substantially total control of the I/O resources, for example, using one single JBOD with two fiber channel arbitrated loop (“FC-AL”) loops 120 shared by at least two information management systems, such as content delivery or router systems such that each information management system may be provided with a number of dedicated storage devices 110 to serve its respective I/O workload. However, it will be understood that the disclosed methods and systems may be implemented with a variety of other information management system I/O resource configurations including, but not limited to, with a single information management system, with multiple JBODs, combinations thereof, etc. It will also be understood with benefit of this disclosure by those of skill in the art that the configuration of storage devices 110 may be optimized in one or more ways using, for example, disk mirroring, redundant array of independent disks (“RAID”) configuration with no mirroring, “smart configuration” technology, auto duplication of hot spots, and/or any other method of optimizing information allocation among storage devices 110.

In this exemplary implementation, AA may be estimated based on average seek time and rotational delay, TR may be the average transfer rate from storage device 110 to the reading arm and across fiber channel 120, Bₘₐₓ may be obtained from cache/buffer manager 130, and Pi may represent the consumption rate for a viewer, i, in the I/O queue which may be impacted, for example, by the client bandwidth, the video playback rate, etc. For illustration purposes, block size (“BL”) is assumed to be constant for this exemplary implementation, although it will be understood that variable block sizes may also be employed in the practice of the disclosed methods and systems. Also for purposes of describing this exemplary embodiment, it is assumed that within one control relationship between the illustrated set of storage devices 110 and I/O manager 140, all existing viewers are serviced in a sequence of cycles or rounds. In each such cycle or round it is assumed that each viewer, i, is served once by fetching Nᵢ number of blocks of a given segment size, followed by a waiting period until the next cycle where another Nᵢ number of blocks is fetched to serve each viewer, i. The time interval of each such cycle may be denoted by “T”.

In this example, uneven distribution of total I/O demands among a number (“NoD”) of multiple storage devices 110 may be quantified or otherwise described in terms of a factor referred to herein as “Workload Skew” (represented herein as “Skew”), the value of which reflects maximum anticipated retrieval demand allocation for a given storage device 1 10 expressed relative to an even retrieval demand distribution among the total number of storage devices 110. For example, assuming a NoD value of 10 storage devices 110, and assuming a total NoV of 1000 viewers, an even demand distribution would be 100 viewers (i.e., a Skew value of 1) per storage device 110. A Skew value of about 1 may be encountered, for example, in systems that employ substantially completely mirrored storage disks, RAID storage disks, or that employ other intelligent disk allocation technology.

Skew values may be an actual value that is measured or monitored, or may be a value that is estimated or assumed (e.g., values assumed for design purposes). Skew values of greater than about 1 may be encountered in less optimized system configurations. For example, if two given disk drives out of a 10 disk drive system have a “hot” Skew value (e.g., Skew value of from about 2 to about 4), this means that most new requests are going to the two given disk drives, which are fully utilized. Under these conditions, system optimization is limited to the two heavily loaded disk drives, with the remaining 8 disk drives being characterized as lightly-loaded or under-utilized so that their performance cannot be optimized. Thus, since run-time I/O demand may not be ideal, during system design or configuration it may be desirable to assume a value of Skew for a given storage device 110 to a number greater than about 1 as a contingency against times when demand may exceed a skew factor of about 1 for the given storage device 110, e.g., Skew may be set to equal 1.4 (or 140%) such that the anticipated maximum number of viewers on the given storage device 110 may be expressed as the product of the Skew value and the number of viewers per device given even demand distribution, or (1.4*100)=140 viewers.

It will be understood with benefit of this disclosure, that performance of storage system 100 may be impacted by a number of other factors that may exist in multi-storage device environments, such as striping, replica, file placements, etc. It will also be understood that although at least one of such factors may be considered if so desired, this is not necessary in the practice of this exemplary embodiment of the disclosed methods and systems which instead may employ-calculated performance characteristics such as AA and the TR to reflect aggregated and logical I/O resource capacity.

Storage device I/O capacity may be represented or otherwise described or quantified using, for example, a combination of NoD, AA and TR values, although it will be understood with benefit of this disclosure that I/O capacity may be represented using any one or two of these particular values, or using any other value or combination of these or other values, that are at least partially reflective of I/O capacity. Likewise, in the practice of the disclosed methods and systems, storage processor memory allocation may be represented or otherwise described or quantified using any value or suitable memory model that is at least partially reflective of memory capacity and/or memory allocation structure.

In one embodiment of the disclosed methods and systems, an integrated logical memory management structure as previously described herein may be employed to virtually partition the total available storage processor memory (“RAM”) into buffer memory, cache memory and free pool memory. In such an exemplary implementation, the total available storage processor memory may be logically partitioned to be shared by cached contents and read-ahead buffers. Among the total RAM, a maximum cache memory size (“M_CACHE”) and minimum free pool memory size (“MIN_FREE_POOL”) may be designated. In this regard, M_CACHE represents maximal memory that may be employed, for example by cache/buffer manager 130 of FIG. 1, for cached contents. MIN_FREE_POOL represents minimal free pool that may be maintained, for example by cache/buffer manager 130. Further information on the concept of MIN_FREE_POOL may be found in U.S. patent application Ser. No. 09/797,201 filed on Mar. 1, 2001 which is entitled SYSTEMS AND METHODS FOR MANAGEMENT OF MEMORY IN INFORMATION DELIVERY ENVIRONMENTS and which has been incorporated herein by reference.

### Resource Modeling for Single Storage Device in Balanced or Substantially-balanced Workload Environments

In one exemplary embodiment of the disclosed systems and methods, a resource model approach to how viewers are served for their I/O demands from one storage device element (e.g., a single storage disk) may be taken as follows, although it will be understood that alternative approaches are also possible. In this exemplary implementation, a cycle time period (“T”) may be taken to represent the time during which each viewer is served once, and in which a number of bytes (“N”) (i.e., the “read-ahead size”) are fetched from a storage device. Assuming that there are NoV viewers with each viewer i to fetch Nᵢ number of blocks, the storage device service time for each viewer may be formulated in two parts: 1) the access time (e.g., including seek and rotation delay); and 2) the data transfer time. Viewers may be served in any suitable sequence, however in one embodiment employing a single storage device element, multiple viewers may be served sequentially.

When the current embodiment is employed for I/O operations in multimedia applications, it may be desirable to ensure continuous playback, i.e. to ensure that there is always sufficient I/O capacity as well as sufficient data contained in the buffer to be played out. In one exemplary embodiment, continuous playback may be ensured by making sure that data consumption rate for each viewer i (“Pᵢ”) multiplied by cycle time period T is approximately equal to block size BL multiplied by fetched number of blocks Nᵢ for the viewer i:

Nᵢ*BL=T*Pᵢ (1)

For continuous playback, cycle time T should be greater than or equal to the storage device service time, i.e., the sum of access time and data transfer time. Under operating conditions, actual access time may be hard to quantify, and therefore may be replaced with average access AA, a value typically provided by storage device vendors such as disk drive vendors. However, it is also possible to employ actual access time when this value is available. Data transfer time may be calculated by any suitable method, for example, by dividing average transfer rate TR into the product obtained by multiplying number of bytes fetched Nᵢ for each viewer by block size BL. Alternatively, data transfer time may be calculated under continuous playback conditions described above by dividing average transfer rate TR into the product obtained by multiplying data consumption rate for each viewer i (“Pᵢ”) by cycle time period T.

Accordingly, in one embodiment cycle time T may be calculated to ensure sufficient I/O capacity for continuous playback for a number of viewers by using the following formula:

$$T \geq NoV * AA / [ 1 - ( {\sum }_{i = 1}^{Nov} {P}_{i} ) / TR ] \qquad ( 2 )$$

Assuming no buffer sharing savings and that each viewer will not start to play back until all Nᵢ blocks are fetched, sufficient buffer data for continuous playback may be ensured by making sure that total available buffer space Bₘₐₓ is greater than or equal to the product obtained by multiplying number of bytes fetched Nᵢ by the block size BL. Alternatively, sufficient buffer data for continuous playback may be ensured by making sure that total available buffer space Bₘₐₓ is greater than or equal to the product obtained by multiplying data consumption rate for each viewer i (“Pᵢ”) by cycle time T. Accordingly, in one embodiment cycle time T may be calculated to ensure sufficient total available buffer space to allow continuous playback for a number of viewers by using the following formula:

$$T \leq {B}_{max} / ( {\sum }_{i = 1}^{Nov} {P}_{i} ) \qquad ( 3 )$$

The disclosed methods and systems may also be employed with information management I/O systems that use buffer sharing techniques to reduce buffer space consumption. In one embodiment, such a buffer sharing technique may share buffer space between different viewers that are served at different times within a cycle T. For example, as a first viewer consumes data starting at the beginning of the cycle T, its need for buffer space drops throughout the cycle. A buffer sharing scheme may make use of the freed buffer space from the first viewer to serve a subsequent viewer/s that is served at a point beginning later in cycle T, rather than reserving the buffer space for use by the first viewer throughout the cycle T. One example of such a buffer sharing strategy is described in R. Ng. And Jinhai Yang, “Maximizing Buffer and Disk Utilizations for News On-Demand,” Proceedings of the 20^{th} VLDB conference, pp. 451-462 (1994)which is incorporated by reference herein. In an embodiment employing such a buffer-sharing scheme, cycle time T may be alternatively calculated to ensure sufficient total available buffer space to allow continuous playback for a number of viewers by using the following revised formula that takes into account buffer space reduction that should be obtainable if a buffer sharing strategy is implemented:

$$T \leq {B}_{max} / [ ( 1 - {B}_{—} Save ) * ( {\sum }_{i = 1}^{Nov} {P}_{i} ) ] \qquad ( {3}^{′} )$$

In equation (3′), the notation “B_Save” is used to denote a constant in the range of from about 0 to about 1 that reflects the percentage of buffer consumption reduction due to buffer sharing.

Using the above relationships to balance sufficient I/O capacity and sufficient total available buffer space, range of cycle time T to ensure uninterrupted continuous playback may be defined in one embodiment for a single storage device by combining Equations (2) and (3) into a resource model equation as follows:

$$NoV * AA / [ 1 - ( {\sum }_{i = 1}^{Nov} {P}_{i} ) / TR ] \leq T \leq {B}_{max} / ( {\sum }_{i = 1}^{Nov} {P}_{i} ) \qquad ( 4 )$$

For an embodiment employing a buffer-sharing scheme, the following equation may be alternatively employed:

$$NoV * AA / [ 1 - ( {\sum }_{i = 1}^{Nov} {P}_{i} ) / TR ] \leq T \leq {B}_{max} / [ ( 1 - {B}_{—} Save ) * ( {\sum }_{i = 1}^{Nov} {P}_{i} ) ] \qquad ( {4}^{′} )$$

In the practice of the disclosed methods and systems, Resource Model Equation (4) may be employed for I/O admission control and the read-ahead estimation. For example, by tracking the number of the existing viewers who are served from a storage device (e.g., disk drive) and monitoring or estimating their playback rates (i.e., data consumption rates), Resource Model Equation (4) may be implemented in the embodiment of FIG. 1 as follows. Resource Model Equation (4) may be employed by I/O manager 140 of storage management processing engine 105 to determine whether or not system 100 has enough capacity to support a given number of viewers without compromising quality of playback (e.g., video playback). For example, if values of I/O capacity and buffer space determined from Resource Model Equation (4) overlap, i.e., no value of cycle time T exists that will satisfy Resource Model Equation (4), then system 100 cannot support all viewers without compromising quality of playback. However, if a value or range of values for cycle time T exist that will satisfy Resource Model Equation (4), then system 100 can support all viewers. Assuming the latter to be the case, Resource Model Equation (4) may be used to determine a range of cycle time T suitable for continuous playback. In the practice of the disclosed methods and systems, viewer data consumption rates (i.e., playback rates) may be monitored in any suitable manner. In one embodiment, monitored data consumption rates may be reported data consumption rates determined in the application layer during session set-up.

Within a range of cycle time values T, Resource Model Equation (4) may be employed to give an estimation of read-ahead size, e.g., see Equations (1) and (12), for each viewer based in part on consumption rates of each viewer, and in doing so may be used to optimize buffer and disk resource utilization to fit requirements of a given system configuration or implementation. In this regard, if value of cycle time T is chosen to be closer to the lower side of cycle time range determined from Resource Model Equation (4), then resulting read-ahead size is smaller, I/O utilization will be higher, and buffer space utilization will be lower. On the other hand, if value of cycle time T is chosen to be closer to the higher side of cycle time range determined from Resource Model Equation (4), then read-ahead size is larger, I/O utilization will be lower, and buffer space utilization will be higher. Using this relationship between I/O utilization and buffer space utilization, Resource Model Equation (4) may be employed in one exemplary embodiment to maximize the number of viewers supported by system 100, given a designated I/O capacity and available buffer space, by adjusting value of cycle time T (and thus, adjusting the read-ahead size for existing and/or new viewers).

Resource Model Equation (4) represents just one exemplary embodiment of the disclosed methods which may be employed to model and balance utilization of I/O capacity and available buffer space, in this case using system I/O performance characteristics such as average access time AA, average transfer rate TR, number of viewers NoV, and their estimated consumption or playback rates Pᵢ. It will be understood with benefit of this disclosure that I/O capacity and available buffer space may be balanced using any other equation, algorithm or other relationship suitable for estimation of I/O capacity and/or buffer space using estimated and/or monitored system I/O performance characteristics. In addition, it will be understood that other system I/O performance characteristics may be utilized including, but not limited to, performance characteristics such as sustained transfer rate, combined internal and external transfer rate, average seek time, average rotation delay, average time spent for inter-cylinder moves by read head, etc. For example, average transfer rate TR may be replaced by sustained transfer rate, and/or average access time AA may be replaced by the sum of average seek time and average rotational delay. In this regard, any single information management system I/O performance characteristic may be utilized alone or in combination with any number of other system I/O performance characteristics as may be effective for the desired utilization calculation. Further, it will be understood that system I/O performance characteristics may be estimated (e.g. average access time AA), monitored (e.g., number of viewers, NoV), or a combination thereof. In this regard, system I/O performance characteristics may be estimated and/or monitored using any suitable methodology, e.g., on a monitored on a real-time basis, monitored on a historical basis, estimated based on monitored data, estimated based on vendor or other performance data, etc. Further information on monitoring of system I/O performance characteristics may be found, for example, described elsewhere herein.

### Resource Modeling for Multiple Storage Devices in Balanced or Substantially-balanced Workload Environments

Resource Model Equation (4) or similar relationships between I/O capacity and available buffer space may be implemented as described above in single storage device environments. Such relationships may also be extended to apply to multiple storage disk environments by, for example, factoring in the performance impact of multiple storage device environments into the estimation of average access AA and the average transfer rate TR in situations where the total set of viewers may be thought of as being served sequentially. Alternative methodology may be desirable where information (e.g., content such as a popular movie) is replicated across several storage devices (e.g., disk drives) so that client demand for the information may be balanced across the replicas. In such cases, a resource model may be developed that considers additional system I/O performance characteristics such as explicit parallelism and its performance improvement in the system, in addition to the previously described system I/O performance characteristics such as average access and transfer rate.

In those cases where I/O workload is substantially balanced (e.g., substantially evenly distributed across multiple storage devices or groups of storage devices) or is near-balanced (e.g., where maximum Skew value for any given storage device or group of storage device is less than about 2, alternatively from about 1 to less than about 2), an analytical-based Resource Model approach may be employed. This may be the case, for example, where information placement (e.g., movie file placement) on multiple storage devices (e.g., multiple disk drives or multiple disk drive groups) is well managed. Such an analytical-based Resource Model may function by estimating or otherwise modeling how workload is distributed across the multiple storage devices or groups of storage devices using, for example, one or more system I/O performance characteristics that is reflective or representative of workload distribution across the devices or groups of devices, e.g., that reflects the unevenness of I/O demand distribution among multiple storage devices. In one embodiment, the constant value “Skew” may be employed. As previously described in relation to FIG. 1, Skew reflects maximum anticipated retrieval demand allocation for a given storage device 110 in terms of an even retrieval demand distribution among the total number of storage devices 110.

One resource model embodiment that may be implemented in substantially balanced parallel-functioning multiple storage device environments may employ substantially the same buffer space constraints as described above in relation to single storage device environments. However, such a resource model may be implemented in a manner that considers additional system I/O performance characteristics to reflect the substantially balanced parallel nature of workload distribution in the determination of I/O capacity constraints. These additional performance characteristics may include, but are not limited to, the number of storage devices NoD against which I/O demands are distributed, and the Skew value. For example, if there are total of NoV viewers and there are total of NoD storage devices or groups of storage devices against which the I/O workload is distributed in parallel, then the number of viewers NoV₁ that each storage device or group of storage device is expected to support may be expressed as follows:

NoV₁=Skew*(NoV/NoD) (5)

Similarly, the Skew value may be used to estimate or approximate the maximal aggregated consumption rates, (“MaxAggRate_perDevice” or “Max{Σ_{i εDevice}Pᵢ; for all storage devices/groups}”) of viewers that are served by each storage device or group of storage devices as follows:

$$Max \{ {\sum }_{iϵ Device} {P}_{i} ; for all storage devices / groups \} ∼ Skew * ( {\sum }_{i = 1}^{Nov} {P}_{i} ) / NoD \qquad ( 6 )$$

Similar to single storage device embodiments, in multiple storage device embodiments cycle time T should be greater than or equal to the maximal aggregate storage device service time for continuous playback, i.e., the maximal aggregate sum of access time and data transfer time for all storage devices or groups of storage devices. Using the above relationships to balance sufficient I/O capacity and sufficient total available buffer space for multiple storage device environments in a manner similar to that employed for Resource Model Equation (4) for single storage device environments, range of cycle time T to ensure continuous playback may be defined in one embodiment for substantially balanced multiple storage device environments by Resource Model Equation (7) as follows:

$$( Skew / NoD ) * NoV * AA / [ 1 - ( Skew / NoD ) * ( {\sum }_{i = 1}^{Nov} {P}_{i} ) / TR ] \leq T \leq {B}_{max} / ( {\sum }_{i = 1}^{Nov} {P}_{i} ) \\ \qquad ( 7 )$$

For an embodiment employing a buffer-sharing scheme, the following equation may be alternatively employed:

$$( Skew / NoD ) * NoV * AA / [ 1 - ( Skew / NoD ) * ( {\sum }_{i = 1}^{Nov} {P}_{i} ) / TR ] \leq T \leq {B}_{max} / [ ( 1 - {B}_{—} Save ) * ( {\sum }_{i = 1}^{Nov} {P}_{i} ) ] \qquad ( {7}^{′} )$$

In the practice of the disclosed methods and systems, Resource Model Equation (7) may be employed for I/O admission control and the read-ahead estimation in a manner similar to Resource Model Equation (4). As with Resource Model Equation (4), the number of existing viewers and their estimated playback rates may be tracked and utilized in system 100 of FIG. 1 by I/O manager 140 of storage management processing engine 105 to determine whether or not system 100 can support all viewers without compromising quality of playback (e.g., video playback). As with Resource Equation (4), if values of I/O capacity and buffer space determined from Resource Model Equation (7) overlap then system 100 cannot support all viewers without compromising quality of playback. However, if a value or range of values for cycle time T exist that will satisfy Resource Model Equation (7), then system 100 can support all viewers. Assuming the latter to be the case, Resource Model Equation (7) may be used to determine a range of cycle time T suitable for continuous playback and to give an estimation of optimal read-ahead size for each viewer in a manner similar to that described for Resource Model Equation (4). Thus, Resource Model Equation (7) may be employed to adjust cycle time T and read-ahead size for existing and new viewers in order to maximize the number of viewers supported by an information management system having multiple storage devices or groups of storage devices.

Resource Model Equation (7) represents just one exemplary embodiment of the disclosed methods which may be employed to model and balance utilization of I/O capacity and available buffer space for an information management system having multiple storage devices or groups of storage devices. As with Resource Model Equation (4), it will be understood that I/O capacity and available buffer space may be balanced using any other equation, algorithm or other relationship suitable for estimation of I/O capacity and/or buffer space using monitored system I/O performance characteristics and/or other system I/O performance characteristics. For example, the Skew value is just one example of an information management system I/O performance characteristic that may be employed to model or otherwise represent uneven distribution of total I/O demands among a number of multiple storage devices NoD, it being understood that any other information management system I/O performance characteristic suitable for modeling or otherwise representing uneven distribution of total I/O demands among a number of multiple storage devices NoD may be employed.

### Resource Modeling for Multiple Storage Devices in Substantially-Unbalanced Workload Environments

In those cases where workload may not be substantially balanced or evenly distributed across multiple storage devices or groups of storage devices (e.g., across disk drives or disk drive groups) a dynamic measurement-based resource model approach may be employed. Although such a measurement-based resource model approach may be implemented under any disk workload distribution (including under substantially balanced workload distributions), it may be most desirable where workload distribution is substantially unbalanced (e.g., in the case of a maximum Skew value of greater than or equal to about 2 for any given one or more storage devices or groups of storage devices). Such a dynamic measurement-based approach becomes more desirable as the possible maximum Skew value increases, due to the difficulty in estimating and pre-configuring a system to handle anticipated, but unknown, future workload distributions.

A dynamic measurement-based resource model may function by actually measuring or monitoring system I/O performance characteristics at least partially reflective of how workload is distributed across multiple storage devices or groups of devices rather than merely estimating or modeling the distribution. In one embodiment, such a measurement-based resource model may function in conjunction with a storage management processing engine capable of tracking workloads of each storage device or group of storage devices such that the maximal number of viewers to a storage device or group of storage devices, and the maximal aggregated consumption rate to a storage device or group of storage devices may be obtained and considered using the resource model.

One resource model embodiment that may be implemented in substantially unbalanced parallel-functioning multiple storage device environments may employ substantially the same buffer space constraints as described above in relation to single storage device and substantially balanced multiple storage device environments. However, such a resource model may be implemented in a manner that considers additional measured or monitored system I/O performance characteristics to reflect the substantially unbalanced parallel nature of workload distribution in the determination of I/O capacity constraints. These additional monitored performance characteristics may include, but are not limited to, the maximal aggregate consumption rates (“MaxAggRate_perDevice”) that may be expressed as “Max{_{i εDevice}Pᵢ; for all devices/groups)}”, and the maximal aggregate number of viewers, (“MaxNoV_perDevice”) that may be expressed as “Max{Number of viewers on a device (or a storage device group); for all devices/groups}”.

Once again, cycle time T should be greater than or equal to the maximal aggregate storage device service time for continuous playback, i.e., the maximal aggregate sum of access time and data transfer time for all storage devices or groups of storage devices. Using the above relationships to balance sufficient I/O capacity and sufficient total available buffer space for multiple storage device environments in a manner similar to that employed for Resource Model Equations (4) and (7), range of cycle time T to ensure continuous playback may be defined in one embodiment for substantially unbalanced multiple storage device environments by Resource Model Equation (8A) as follows:

$${Max NoV}_{—} perDevice * AA / [ 1 - {MaxAggRate}_{—} perDevice / TR ] \leq T \leq {B}_{max} / ( {\sum }_{i = 1}^{Nov} {P}_{i} ) \qquad ( 8 A )$$

For an embodiment employing a buffer-sharing scheme, the following equation may be alternatively employed:

$${Max NoV}_{—} perDevice * AA / [ 1 - {MaxAggRate}_{—} perDevice / TR ] \leq T \leq {B}_{max} / [ ( 1 - {B}_{—} Save ) * ( {\sum }_{i = 1}^{Nov} {P}_{i} ) ] \qquad ( 8 {A}^{′} )$$

In the practice of the disclosed methods and systems, Resource Model Equation (8A) may be employed for I/O admission control and the read-ahead estimation in a manner similar to Resource Model Equations (4) and (7). In one embodiment, the maximal aggregate consumption rates and the maximal aggregate number of viewers may be tracked and utilized in system 100 of FIG. 1 by I/O manager 140 of storage management processing engine 105 to determine whether or not system 100 can support all viewers without compromising quality of playback (e.g., video playback). As with Resource Equations (4) and (7), if values of I/O capacity and buffer space determined from Resource Model Equation (8A) overlap then system 100 cannot support all viewers without compromising quality of playback. However, if a value or range of values for cycle time T exist that will satisfy Resource Model Equation (8A), then system 100 can support all viewers. Assuming the latter to be the case, Resource Model Equation (8A) may be used to determine a range of cycle time T suitable for continuous playback and to give an estimation of optimal read-ahead size for each viewer in a manner similar to that described for Resource Model Equations (4) and (7). Thus, Resource Model Equation (8A) may be employed under unbalanced workload conditions to adjust cycle time T and read-ahead size for existing and new viewers in order to maximize the number of viewers supported by an information management system having multiple storage devices or groups of storage devices.

### Implementation of Resource Models in Presence of Background System I/O Activities

Embodiments of the disclosed methods and systems, such as Resource Model Equations (4), (7) and (8A), may be implemented with a variety of information management system I/O configurations. For example, the disclosed resource models described above may be implemented as I/O admission control policies that act as a “soft control” to I/O scheduling. In addition, it is also possible that various I/O scheduling algorithms may be applied in conjunction with the disclosed I/O admission control policies. For example, the disclosed methods and systems may be implemented with earliest-deadline-first scheduling schemes as described in A. Reddy and J. Wylie, “I/O Issues in a Multimedia System”, IEEE Computer, 27(3), pp. 69-74, 1994; and R. Haskin, “Tiger Shark—A Scalable File System for Multimedia”, IBM Journal of Research and Development, Vol. 42, No. 2, pp. 185-198, March 1998, each of which is incorporated herein by reference. In such a case, the deadline of an I/O request may be calculated, for example, based on cycle time T and consumption rate Pᵢ.

The disclosed methods and systems may also be implemented in systems employing both lower level admission control policies and round-based disk arm scheduling techniques. Examples of conventional storage system configurations employing round-based scheduling techniques and admission control policies (e.g., SCAN), are described in T. Teorey and T. Pinkerton, “A comparative analysis of disk scheduling policies”, Communications of the ACM, 15(3), pp. 177-184, 1972, which is incorporated herein by reference. In such conventional implementations, it is typically desirable that lower level admission control policies be closely coupled with the disk arm scheduling algorithm. Although it is possible to modify the disclosed resource model embodiments (e.g., Resource Model Equations (4), (7) and (8A)) to reflect disk arm scheduling factors, this is not necessary in the logical volume management level. Instead, average access AA and average transfer rate TR may be relied on to factor in the impacts of disk arm level details. Advantageously, this allows lower level implementation details to be transparent.

Embodiments of the disclosed methods and systems may also be implemented with a variety of information management system operations. For example, Resource Model Equations (4), (7) and (8A) may be implemented in information management system operations including, but not limited to, read-only activities for video streams. Such activities typically comprise the major portion of I/O workloads for information management systems, such as content delivery systems, content router systems, etc. However, the disclosed methods and systems may also be implemented in conjunction with other types or classes of I/O activities, including background system I/O activities such as the writing of large video files to system storage devices (e.g., when updating content on one or more storage devices), and/or for the accessing of relatively small files (e.g., metadata files, index files, etc.). When implemented in conjunction with such activities, the disclosed methods and systems may be modified so as to consider workload demands particular to these types of I/O activities, for example in a manner as follows.

In one embodiment, the disclosed admission control policies may be implemented in a manner that addresses writing operations for large continuous file (e.g., writing of relatively large video files as part of controlled or scheduled content provisioning activity), and/or access operations for relatively small files. Writing operations for relatively large files may occur at any time, however, it is common to attempt to schedule them during maintenance hours or other times when client demand is light. However, it is also possible that such writing operations may occur during primary system run-time when client demand is relatively heavy, e.g., when a remote copy is downloaded to a local server. Furthermore, even in the case of file writing operations scheduled during maintenance time windows, the workload for writing relatively large files may consume a significant portion of buffer space and I/O capacity for a given period of time, and especially in the event that client demand surges unexpectedly when the system is updating its contents. Small file access may not necessarily consume a lot of I/O resources, but may have higher timing requirements. Such small files may contain critical information (e.g., metadata, index file data, I-node/D-node data, overhead data for stream encoding/decoding, etc.), so that I/O demand for these tasks should be served as soon as possible.

Under the above-described conditions of heavy resource demand and/or critical timing for access, embodiments of the disclosed methods and systems may be implemented to provide a resource manager that at least partially allocates information management system I/O resources among competing demands, for example, by using the management layer to define a certain portion or percentage of I/O capacity, and/or certain portion or percentage of buffer space, allowed to be used for writing operations such as content updating. In such embodiments, the allocated portion of either I/O capacity or buffer space may be fixed, may be implemented to vary with time (e.g., in a predetermined manner, based on monitored information management system I/O resources/characteristics, etc.), may be implemented to vary with operator input via a storage management system, etc.

In one embodiment, resource utilization balance may be maintained by reserving a fixed or defined portion of cycle time T to be utilized for content-updating/content provisioning workloads. In this embodiment, the reserved portion may be configurable on a real-time basis during runtime, and/or be made to vary with time, for example, so that the portion of T reserved for content-updating may be higher when an information management system is in maintenance mode, and lower when the system is in normal operational mode. In one exemplary embodiment, a configurable resource parameter (e.g., “Reserved_Factor”) having a value of from about 0 to about 1 may be employed to reflect portion or percentage of I/O resources allocated for internal system background processing activity (e.g., large file updates, small file accesses, etc.). In this embodiment, the balance of I/O resources (e.g., “1−Reserved_Factor”) may be used for processing the admission of new viewers.

A configurable resource parameter such as Reserved_Factor may be fixed in value (e.g., a predetermined value based on estimated processing background needs), or may be implemented to vary with time. A variable resource parameter may be implemented using at least two parameter values (e.g., at least two constant values input by operator and/or system manager) that vary according to a predetermined schedule, or may be a dynamically changing value based at least in part on monitored information management system resources/characteristics, such as monitored background system processing activity. For example, a first value of Reserved_Factor may be set to be a predetermined constant (e.g., about 0.1) suitable for handling normal processing background activities at times of the day or week during which an information management system workload is anticipated to include primarily or substantially all read-only type activities for video streams. A second value of Reserved_Factor may be set to be a predetermined constant (e.g., about 0.3) suitable for handling content provisioning processing workloads at times of the day or week during which content provisioning activities are scheduled.

A variable resource parameter may optionally be implemented to vary dynamically according to monitored information management system I/O resources/characteristics, such as monitored background system processing activity. For example, in one exemplary embodiment, processing background system activity may be monitored (e.g., by monitoring arrival queue of background I/O requests to determine if the existing value of Reserved_Factor needs to be changed. Background system I/O activity includes, for example, write or update requests for new content, access to file system D-node/I-node data, and/or access to overhead blocks in a continuous or streaming file. If the background I/O queue increases in size, the value of Reserved Factor may be increased, proportionally or using some other desired relationship. If the background I/O queue decreases in size, the value of Reserved_Factor may be decreased proportionally or using some other desired relationship. If the background I/O queue is empty, the value of Reserved Factor may be set to zero. If desired, upper and/or lower bounds for Reserved_Factor (e.g. upper bound of about 0.05; lower bound of about 0.4) may be selected to limit the range in which the Reserved_Factor may be dynamically changed.

In one exemplary embodiment, Reserved_Factor may be dynamically varied from a first value (“Old Reserved_Factor”) to a second value (“New Reserved_Factor”) in a manner directly proportional to the background system activity workload. For example, Reserved_Factor may be dynamically varied from a first value (“Old_Reserved_Factor”) to a second value (“New_Reserved_Factor”) in a manner directly proportional to a change from a first monitored background system I/O queue size (“Old_Queue_Depth”) to a second monitored background system I/O queue size (“New_Queue_Depth”) using a proportionality factor (“C”) and solving for the value “New_Queue_Depth” in the following equation:

New_{—}Reserved_{—}Factor−Old_{—}Reserved_{—}Factor=[C*(New_{—}Queue_{—}Depth−Old_{—}Queue_{—}Depth)] (8B)

In this exemplary embodiment, Old_Reserved_Factor may be a pre-determined initial value of Reserved_Factor set by, for example, operator or system manager input, or alternatively may be a value previously determined using equation (8B) or any other suitable equation or relationship.

It will be understood with benefit of this disclosure that equation (8B) is just one exemplary equation that may be employed to dynamically vary a resource parameter, such as Reserved_Factor, in a directly proportional manner with changing processing background activity. It will also be understood that the variables and constant “C” employed in equation (8B) are exemplary as well. In this regard, other equations, algorithms and/or relationships may be employed to dynamically vary the value of a resource parameter, such as Reserved_Factor, based on changes in background processing activity. For example, a resource parameter may be dynamically varied in a non-directly proportional manner, using other equations, algorithms or relationships, e.g., using proportional (“P”), integral (“I”), derivative (“D”) relationships or combinations thereof, such as proportional-integral (“PI”), derivative-integral-derivative (“PID”), etc. Furthermore, it will be understood that background processing activity may be measured or otherwise considered using alternative or additional factors to background I/O queue size, for example, by counting pending background I/O requests, etc.

Under certain circumstances, ongoing processing requirements (e.g., for ongoing video streams) may be sufficiently high so that a newly determined resource parameter value such as New_Reserved_Factor may not be implemented without reducing interruption. To address this scenario, a dynamically-changing resource parameter embodiment such as previously described may be optionally implemented in a manner that controls rapid changes in parameter values to avoid interruptions to ongoing operations (e.g., ongoing streams being viewed by existing viewers). For example, ongoing streams may be allowed to terminate normally prior to changing the value of Reserved_Factor, so that no interruption to existing viewers occur. This may be done, for example, by waiting until available processing resources are sufficient to increase the value of Reserved_Factor to New_Reserved_Factor, or by incrementally increasing the value of Reserved_Factor as streams terminate and additional processing resources become available.

Alternatively, processing background requirements may be given priority over service interruptions, in which case the existing streams of ongoing viewers may be immediately terminated as necessary to increase the Reserved_Factor to its newly determined value. In such an embodiment, existing streams may be selected for termination based on any desired factor or combination of such factors, such as duration of existing stream, type of viewer, type of stream, class of viewer, etc. In the latter case, lower classes of viewers may be terminated prior to higher class viewers and, if desired, some higher classes of viewers may be immune from termination as part of the guaranteed service terms of a service level agreement (“SLA”), other priority-indicative parameter (e.g., CoS, QoS, etc), and/or other differentiated service implementation. Examples of possible SLA implementations, priority-indicative parameters and other differentiated service features may be found described in co-pending U.S. patent application Ser. No. 09/879,810 filed on Jun. 12, 2001 which is entitled SYSTEMS AND METHODS FOR PROVIDING DIFFERENTIATED SERVICE IN INFORMATION MANAGEMENT ENVIRONMENTS which is incorporated herein by reference.

In operation, an I/O resource manager may utilize such a resource parameter to allocate cycle time T, for example, by using the parameter Reserved_Factor to determine a value of cycle T such that (1−Reserved Factor)*T satisfies normal continuous file workload. Under such conditions, (1−Reserved_Factor)*T should be greater than or equal to the storage device service time, i.e., the sum of access time and data transfer time. Accordingly, in this embodiment, cycle time T may be calculated to ensure sufficient I/O capacity for continuous playback for a number of viewers by using the following Resource Model Equations (9), (10) and (11) that correspond to respective Resource Model Equations (4), (7) and (8A).

For single storage device case:

$$NoV * AA / [ 1 - Reserved\_Factor - ( {\sum }_{i = 1}^{Nov} {P}_{i} ) / TR ] \leq T \leq ( 1 - Reserved\_Factor ) * {B}_{max} / [ ( 1 - B\_Save ) * ( {\sum }_{i = 1}^{Nov} {P}_{i} ) ] \qquad ( 9 )$$

For multiple storage device case under substantially balanced conditions:

$$( Skew / NoD ) * NoV * AA / [ 1 - Reserved\_Factor - ( Skew / NoD ) * ( {{\sum }_{i = 1}}^{Nov} {P}_{i} ) / TR ] \leq T \leq ( 1 - Reserved\_Factor ) * {B}_{max} / [ ( 1 - B\_Save ) * ( {\sum }_{i = 1}^{Nov} {P}_{i} ) ] \qquad ( 10 )$$

For multiple storage device case under substantially unbalanced conditions:

$$MaxNoV\_perDevice * AA / [ 1 - Reserved\_Factor - MaxAggRate\_perDevice / TR ] \leq T \leq ( 1 - Reserved\_Factor ) * {B}_{max} / [ ( 1 - B\_Save ) * ( {\sum }_{i = 1}^{Nov} {P}_{i} ) ] \qquad ( 11 )$$

In the practice of the disclosed methods and systems, Resource Model Equations (9), (10) and (11) may be employed for I/O admission control and the read-ahead estimation in a manner similar to that previously described for Resource Model Equations (4), (7) and (8A).

### Resource Modeling: Read-ahead Size Calculation

In another embodiment of the disclosed methods and systems, read-ahead size may also or alternatively be determined in addition to making admission control decisions and cycle time determinations. Read-ahead size may be so determined in one exemplary embodiment based on the previously described relationship given in equation (1). In this regard, equation (1) may be re-written to derive the number of read-ahead blocks for each viewer Nᵢ given the block size BL, the estimated consumption rate Pᵢ and the calculated cycle T, as follows:

Nᵢ=T*Pᵢ/BL (12)

The calculated number of read-ahead blocks Nᵢ may not always be an integer number, and may be adjusted to an integer number using any desired methodology suitable for deriving an integer number based on a calculated non-integer value, e.g., by rounding up or rounding down to the nearest integer value. In one exemplary embodiment, read-ahead size may be implemented based on a calculated value of Nᵢ by alternately retrieving the largest integer less than the calculated Nᵢ, and the smallest integer larger than the calculated Nᵢ, in different (e.g., successively alternating) cycles. In this way, it is possible to retrieve an average amount of data for each viewer that is equivalent to Nᵢ, while at the same time enabling or ensuring continuous playback.

### Resource Modeling for Multiple Buffering Implementations

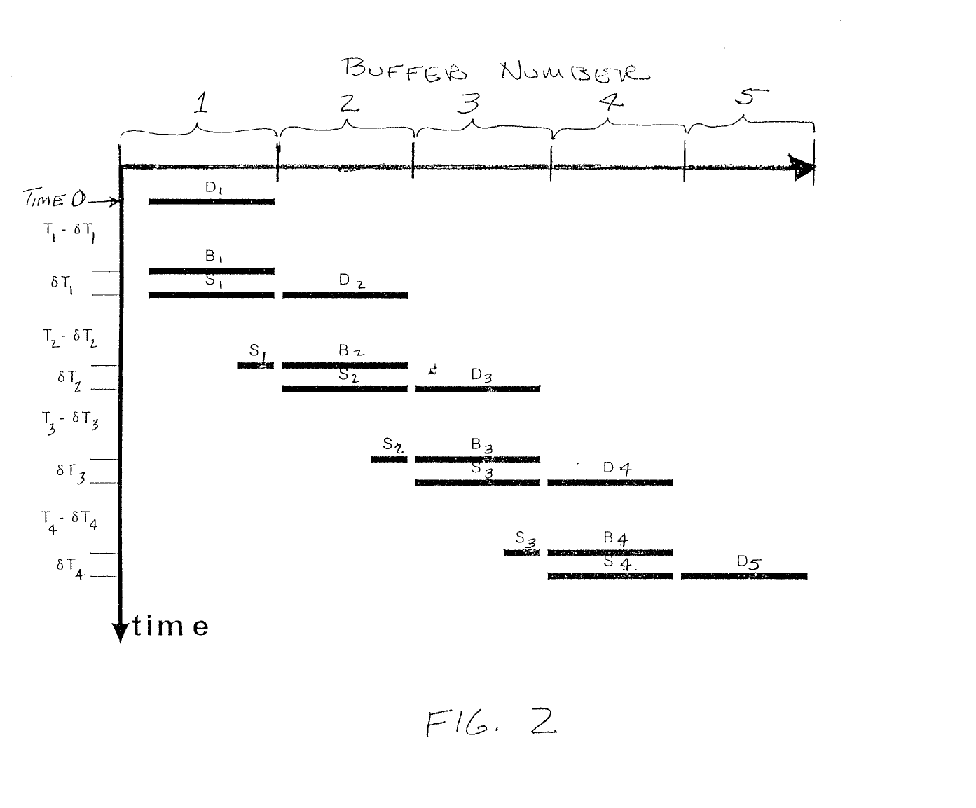

Embodiments of the disclosed methods and systems may also be implemented in a manner that is capable of handling unpredictable playback dynamics, i.e., to address actual I/O activities. In this regard, buffer space may be allocated in a manner that is event driven and that reflects the state of each viewer at any instantaneous moment. For example, in one exemplary embodiment, a sliding window buffer approach that includes multiple buffers may be implemented. One example of a sliding window buffer approach using two buffers is illustrated in FIG. 2. As shown in FIG. 2, at time 0 a first buffer space of N (read-ahead) blocks is allocated as the “D₁” buffer” to fetch data from a storage device (e.g., a storage disk), and the D₁ buffer is filled before T₁ (cycle) seconds expire. After the first buffer space has been filled and becomes ready for being sent it is denoted in FIG. 2 as the “B₁” buffer. In a transient fraction of time (“δT₁”), sending of data in the B₁ buffer starts the first buffer space becomes a sent “S₁” buffer as illustrated in FIG. 2. Simultaneously with sending data in the B₁ buffer and with change of the B₁ buffer to the D₁ buffer, a second buffer space is allocated as the “D₂” buffer to fetch data in the second cycle T₂ and is filled and sent in the same manner as the first buffer space in the first cycle. The I/O cycles continue sequentially in the same way as shown in FIG. 2.

Due to the event driven nature of the double buffering embodiment of FIG. 2, unexpected changes in consumption may not substantially change buffer space requirements. If a given viewer experiences network congestion, for example, then the time it takes to transmit the Sᵢ buffer will take longer than Tᵢ−δTᵢ, meaning that the next Dᵢ₊₁ buffer will transition into a Bᵢ₊₁ buffer and stay there for sufficient time until the Sᵢ buffer is transmitted. However, space for the Dᵢ₊₂ buffer will not be allocated until the S₁ buffer is completely sent. Therefore, using this exemplary embodiment, buffer space consumption may remain substantially stable in response to unexpected system behaviors.

Those embodiments employing multiple buffers require increased buffer space, e.g. use of double buffering serves to double the buffer space requirement. As a consequence, the disclosed resource model methodology (e.g., any given one of the previously described Resource Model Equations) may be modified so that various buffering implementation schemes (and their impacts on actual buffer consumption) may be reflected. For example, in one exemplary embodiment, a buffer memory parameter (“Buffer_Multiplcity”) to reflect characteristics of implemented buffering techniques and their implicit buffering requirement alteration. In the case of multiple buffer implementation, value of a Buffer_Multiplcity factor may be set after characteristics of a multiple buffer implementation are decided upon. As just one example, the buffer memory parameter Buffer_Multiplcity may be employed to represent multiple buffering by modifying respective Resource Model Equations (9), (10) and (11) as follows:

For single storage device case:

$$NoV * AA / [ ( 1 - Reserved\_Factor ) - ( {\sum }_{i = 1}^{Nov} {P}_{i} ) / TR ] \leq T \leq ( 1 - Reserved\_Factor ) * {B}_{max} / \{ Buffer\_Multiplcity * [ ( 1 - B\_Save ) * ( {\sum }_{i = 1}^{Nov} {P}_{i} ) ] \qquad ( 13 )$$

For multiple storage device case under substantially balanced conditions:

$$( Skew / NoD ) * NoV * AA / [ 1 - Reserved\_Factor - ( Skew / NoD ) * ( {\sum }_{i = 1}^{Nov} {P}_{i} ) / TR ] \leq T \leq ( 1 - Reserved\_Factor ) * {B}_{max} / \{ Buffer\_Multiplcity * [ ( 1 - B\_Save ) * ( {\sum }_{i = 1}^{Nov} {P}_{i} ) ] \} \qquad ( 14 )$$

For multiple storage device case under substantially unbalanced conditions:

$$MaxNoV\_perDevice * AA / [ 1 - Reserved\_Factor - MaxAggRate\_perDevice / TR ] \leq T \leq ( 1 - Reserved\_Factor ) * {B}_{max} / \{ Buffer\_Multiplcity * [ ( 1 - B\_Save ) * ( {\sum }_{i = 1}^{Nov} {P}_{i} ) ] \} \qquad ( 15 )$$

In the practice of the disclosed methods and systems, Resource Model Equations (13), (14) and (15) may be employed for I/O admission control and read-ahead estimation in a manner similar to that previously described for Resource Model Equations (9), (10) and (11).

It will be understood with benefit of this disclosure that the previously described example of a double buffering scheme represents just one embodiment of a double buffering scheme that may be implemented to reduce buffer consumption. It will also be understood that such a double buffering embodiment is exemplary only, and that other types of multiple buffering schemes may be employed including, but not limited to, triple buffering schemes that may be implemented to address hiccups in continuous information delivery environments.

### Resource Modeling for Integrated Logical Memory Management Structure Implementations

In those embodiments employing the previously described integrated logical memory management structure (e.g., logically partitioned buffer memory, cache memory and free pool memory), the presence of cache in the storage processor means that the total available memory will be shared by cached contents and read-ahead buffers. For example, in one exemplary embodiment the total available memory for a storage processor may be represented by the parameter “RAM”, the parameter “M_Cache” may be used to represent the maximal portion of RAM that a cache/buffer manager is allowed to use for cached contents, and the parameter “Min_Free_Pool” may be used to represent the minimal free pool memory maintained by the cachelbuffer manager. The parameters RAM, M_Cache, and Min_Free_Pool may be obtained, for example, from the cache/buffer manager. In this exemplary embodiment, the total available memory for the read-ahead Bₘₐₓ may be expressed as:

Bₘₐₓ=RAM−M_Cache−Min_{—}Free_{—}Pool (16)

When such an integrated buffer/cache memory embodiment is implemented there are at least two different ways in which a viewer may consume available resources (e.g., I/O, memory, etc). In one case, a given viewer may be reading information for its read-ahead buffer from one or more storage devices and therefore consume both buffer space and I/O capacity. In another case, a given viewer may be able to read information from the cache portion of memory, and thus only consume buffer memory space. As described in U.S. patent application Ser. No. 09/797,201 which has been incorporated by reference herein, one embodiment of integral buffer/cache design may be implemented to reserve a read-ahead size of contents from the cache manager or storage processor for the viewer in order to avoid hiccups if the interval is replaced afterward. Further, such an integrated buffer/cache design may be implemented to discount the read-ahead size of cached contents from cache memory consumption and make it accountable as a part of buffer space consumption.

When such an integrated buffer/cache memory design is employed, the disclosed methods and systems may be implemented in a manner that differentiates the above-described two viewer read scenarios, for example, by monitoring and considering the number of viewers reading information from storage devices (e.g., disk drives) and/or the number of viewers reading information from cache portion of memory. For example, in one exemplary embodiment the total number of viewers that are currently reading their contents from storage devices (“NoV_IO”) may be tracked or otherwise monitored. Only these NoV_IO viewers require I/O resources, however all NoV viewers need buffer spaces. In this exemplary embodiment, NoV_IO may be considered in the disclosed resource model by modifying respective Resource Model Equations (13), (14) and (15) as follows:

For single storage device case:

$$NoV\_IO * AA / [ 1 - Reserved\_Factor - ( {\sum }_{i = 1}^{NoV\_IO} {P}_{i} ) / TR ] \leq T \leq ( 1 - Reserved\_Factor ) * {B}_{max} / \{ Buffer\_Multiplcity * [ ( 1 - B\_Save ) * ( {\sum }_{i = 1}^{Nov} {P}_{i} ) ] \} \qquad ( 17 )$$

For multiple storage device case under substantially balanced conditions:

$$( Skew / NoD ) * NoV\_IO * AA / [ 1 - Reserved\_Factor - ( Skew / NoD ) * ( {\sum }_{i = 1}^{NoV\_IO} {P}_{i} ) / TR ] \leq T \leq ( 1 - Reserved\_Factor ) * {B}_{max} / \{ Buffer\_Multiplcity * [ ( 1 - B\_Save ) * ( {\sum }_{i = 1}^{Nov} {P}_{i} ) ] \} \qquad ( 18 )$$

For multiple storage device case under substantially unbalanced conditions:

$$MaxNoV\_perDevice * AA / [ 1 - Reserved\_Factor - MaxAggRate\_perDevice / TR ] \leq T \leq ( 1 - Reserved\_Factor ) * {B}_{max} / \{ Buffer\_Multiplcity * [ ( 1 - B\_Save ) * ( {\sum }_{i = 1}^{Nov} {P}_{i} ) ] \} \qquad ( 19 )$$

In the above Resource Model Equations (17), (18) and (19), the total available memory for read-ahead Bₘₐₓ may be calculated using equation (16). The lower bounds may be max calculated using the total number of viewers that are currently reading from disk drives NoV_IO. The upper bounds may be calculated using the total number of viewers supported by the system (NoV). Resource Model Equations (17), (18) and (19) may be employed for I/O admission control and read-ahead estimation in a manner similar to that previously described for Resource Model Equations (13), (14) and (15).

When an integrated buffer/cache memory embodiment is employed, an optional buffer read-ahead buffer cap or limit may be implemented to save memory for cache, for example, in situations where workload is concentrated in only a portion of the total number of storage devices (e.g., workload concentrated in one disk drive). Such a cap or limit may become more desirable as value of aggregate consumption or playback rate Pᵢ gets closer to value of storage device transfer rate capacity TR. With onset of either or both of these conditions, increases in read-ahead buffer size consume memory but may have a reduced or substantially no effect toward increasing system throughput. Therefore read ahead buffer size may be limited using, for example, one of the following limiting relationships in conjunction with the appropriate respective resource model equation (17), (18) or (19) described above:

For single storage device case equation (17):

$$0.2 \leq ( 1 - Reserved\_Factor ) - ( {\sum }_{i = 1}^{Nov} {P}_{i} ) / ( TR ) \qquad ( 17 B )$$

For multiple storage device case under substantially balanced conditions equation (18):

$$0.2 \leq ( 1 - Reserved\_Factor ) - ( Skew / NoD ) * ( {\sum }_{i = 1}^{Nov} {P}_{i} ) / ( TR ) \qquad ( 18 B )$$

For multiple storage device case under substantially unbalanced conditions equation (19):

0.2≦(1−Reserved_{—}Factor)−(MaxAggRate_{—}perDevice/TR) (19B)

For example, the appropriate limiting relationship (17B), (18B) or (19B) may be substituted for the matching terms within the respective Resource Model Equation (17), (18) or (19) to limit the denominator of the left hand side of the respective Resource Model Equation to a limiting value of at least 0.2 so as to limit read-ahead size. In this regard, the limiting value of 0.2 is exemplary only, and may be varied as desired or necessary to fit particular applications.

It will be understood with benefit of this disclosure by those of skill in the art that the particular Resource Model Equations previously described are exemplary only, and that other equations, algorithms or other relationships may be employed using various other combinations of parameters described herein, and/or combinations of other parameters not explicitly described herein but that represent one or more information management system resource characteristics and/or operational characteristics as described elsewhere herein. In this regard, Resource Model Equations may be selected and/or customized to fit given information management system configurations. For example, the parameter Skew is optional for implementations that track and use the parameters MaxAggRate_perDevice and MaxNoV_perDevice to gain a more realistic view of workload distribution. Similarly, although the parameter B_Save appears in each of Resource Model Equations (17), (18) and (19), this parameter is not needed and may be removed from these equations in those embodiments where no explicit buffer sharing techniques are employed.

It will also be understood that the disclosed methods and systems for I/O resource management may be employed to manage I/O resources based on modeled and/or monitored I/O resource information in a wide variety of information management system configurations including, but not limited to, any type of information management system that employs a processor or group of processors suitable for performing these tasks. Examples include a buffer/cache manager (e.g., storage management processing engine or module) of an information management system, such as a content delivery system. Likewise resource management functions may be accomplished by a system management engine or host processor module of such a system. A specific example of such a system is a network processing system that is operable to process information communicated via a network environment, and that may include a network processor operable to process network-communicated information and a memory management system operable to reference the information based upon a connection status associated with the content.

### Resource Modeling for Information Management System Implementations

In one exemplary embodiment, the disclosed methods and systems may be implemented in an information management system (e.g., content router, content delivery system, etc.) to perform deterministic resource management in a storage management processing engine or subsystem module coupled to the information management system, which in this exemplary embodiment may act as an “I/O admission controller”. Besides I/O admission control determinations, the disclosed methods and systems may also be employed in this embodiment to provide an estimation of read-ahead segment size. When implemented in conjunction with an integrated buffer/cache memory configuration such as described elsewhere herein, it is possible that introduction of a new viewer as described below may force a existing viewer to give up its interval in the cache and to come back to the I/O task pool. Thus, in such a case, admittance of a new viewer may result in admittance of two viewers into the I/O task pool.

Although this exemplary embodiment may be implemented in an information management system under any of the conditions described herein (e.g., single storage device, multiple storage device/substantially balanced conditions, multiple storage device/substantially unbalanced conditions), the following discussion describes one example implementation in which an analytical-based resource model approach may be employed to manage I/O resources in an information management system where workload is substantially balanced or evenly distributed across multiple storage devices or groups of storage devices (e.g., across disk drives or disk drive groups). It will be understood with benefit of this disclosure that a measurement-based resource model approach may be implemented in a similar manner, e.g., under information management system I/O conditions where workload is not substantially balanced or evenly distributed across multiple storage devices or groups of storage devices, or under any other information management system I/O conditions (e.g., substantially balanced workload across multiple storage devices) where implementation of such a measurement-based resource model is desired.

In this embodiment, an analytical-based resource model approach may be implemented by a storage processor such as storage management processing engine 105 of FIG. 1. In such a case, storage management processing engine 105 may be employed to monitor system I/O performance characteristics, including the total number of viewers supported by the system (NoV), the total number of viewers that are currently reading from storage devices 110 (NoV_IO), and the aggregated playback rates (e.g., Sum of Pᵢ values) during system operation.

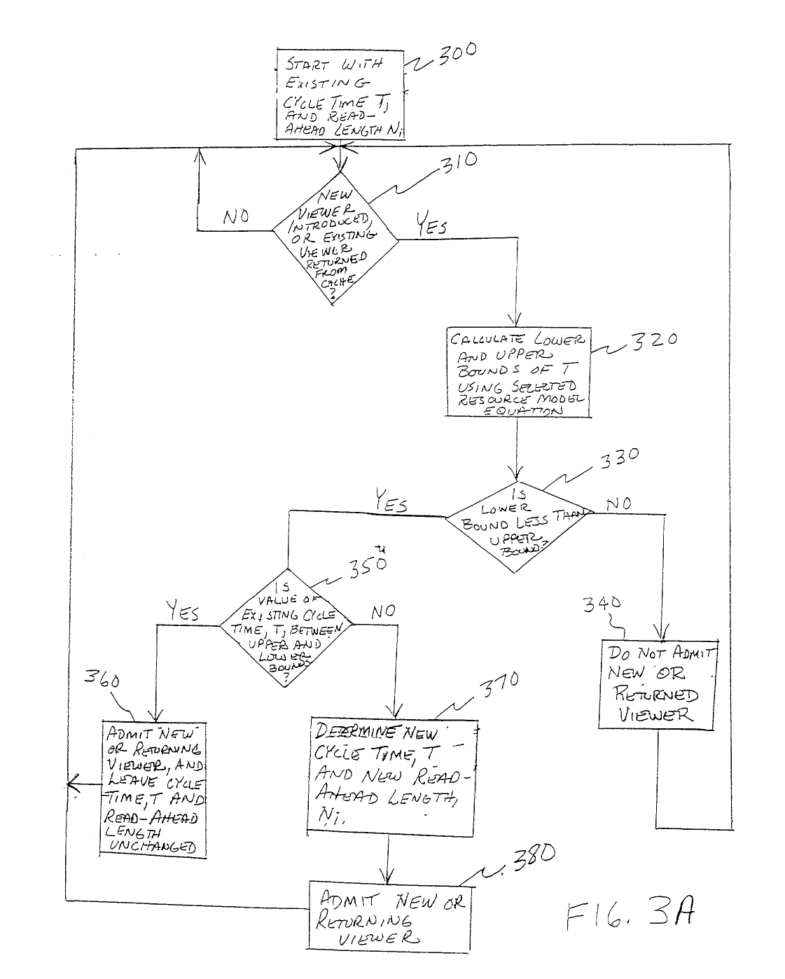

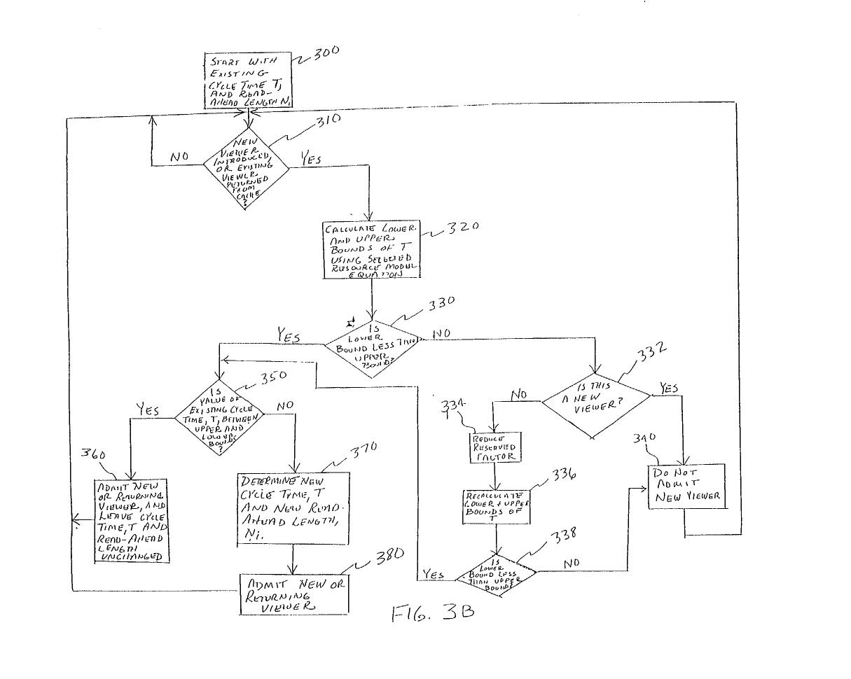

As illustrated in FIG. 3A, a storage system 100 may start in step 300 with an existing cycle time T and an existing read-ahead size Nᵢ, which remain unchanged in step 310 as long as no new viewer is introduced or no existing viewer is returned from cached state to I/O state. However, if in step 310 a new viewer is introduced or an existing viewer is returned from cached state to I/O state due to removal of its interval from cache, a selected Resource Model Equation (e.g., Resource Model Equation (18)) may be used in step 320 to calculate a lower-bound value of cycle time T (i.e., value calculated from I/O capacity function or left-hand side of the equation) and an upper-bound value of cycle time T (i.e., value calculated from buffer space function or right-hand side of the equation), with both calculations made including the new or returning viewer

$$Lower Bound = MaxNoV\_perDisk * AA / [ 1 - Reserved\_Factor - MaxAggRate\_perDisk / TR ]$$

$$Upper Bound = ( 1 - Reserved\_Factor ) * {B}_{max} / \{ Buffer\_Multiplcity * [ ( 1 - B\_Save ) * ( {\sum }_{i = 1}^{Nov} {P}_{i} ) ] \}$$

Lower and upper bound values of cycle time T calculated in step 320 may be compared in step 330 to determine whether or not the lower-bound value is less than the upper-bound value (i.e., to determine whether or not the values of I/O capacity and buffer space overlap or whether or not a possible value or range of possible values of cycle time T exist to balance said I/O capacity with said buffer memory space) or, for example, whether or not the lower bound is less than the upper-bound value by a pre-determined threshold amount or range of values (e.g., Upper Bound−Lower Bound≧0.05). In either case, if the specified relationship is not true (i.e., lower bound value is greater than or equal to upper-bound value, or Upper Bound−Lower Bound is not≧0.05), then storage management processing engine 105 may refuse to admit the new or returning viewer to its I/O task pool and the values of cycle time T and read-ahead size N. may be left unchanged as shown in step 340. However, if in step 330 the calculated lower bound value is less than the calculated upper-bound value (i.e., values of I/O capacity and buffer space do not overlap), then storage management processing engine 105 may admit the new viewer or returning viewer to its I/O task pool as shown in steps 360 and 380, after determining in step 350 whether the existing cycle time T and read-ahead size Nᵢ need to be modified to take into account the new or returning viewer.

In step 350, the existing value of cycle time T may be compared to the range between the newly determined lower bound and the newly determined upper bound calculated in step 320. In step 360, the new or returning viewer may be admitted, and the existing value of cycle time T and the existing read-ahead size may be left unchanged, if the existing value of cycle time T falls within the range between the newly determined lower bound and the newly determined upper bound. However, if the existing value of cycle time T falls outside the value range between the newly determined lower bound and the newly determined upper bound, then a new value of cycle time T may be selected or otherwise determined in step 370 from the range of values existing between the newly determined lower and the upper bounds. This newly determined cycle time T may then be used in step 370 (e.g., by storage management processing engine 105) to determine a new value of read-ahead segment size N. for all existing viewers using, for example, equation (12) and the new or returning viewer admitted in step 380.

Alternatively, in those embodiments employing a Resource Model Equation that uses a value of Reserved_Factor, then an attempt may be made to modify the existing value of Reserved_Factor to allow admittance of an existing viewer that is returning from cache so as to minimize disruption to the returning viewer if the specified relationship found not true in step 330, as shown in the exemplary embodiment of FIG. 3B. As shown in FIG. 3B, if it is determined in step 332 that a new viewer is being introduced, then storage management processing engine 105 may refuse to admit the new viewer to its I/O task pool and the values of cycle time T and read-ahead size N may be left unchanged as shown in step 340. However, if the viewer is determined in step 332 to be an existing viewer returning from cached state to I/O state, then value of Reserved_Factor may be reduced by a given amount in step 334 (e.g., from a value of about 0.2 to a value of about 0.1), and then lower and upper bound values of cycle time T re-calculated in step 336 using the reduced value of Reserved_Factor. The recalculated lower and upper bound values of cycle time T calculated in step 336 may be compared in step 338 to determine whether or not the lower-bound value is less than the upper-bound value, or whether or not the lower bound is less than the upper-bound value by a pre-determined threshold amount. In either case, if the specified relationship is not true, then storage management processing engine 105 may refuse to admit the returning viewer to its I/O task pool and the values of cycle time T and read-ahead size Nᵢ may be left unchanged in step 340. However, if the specified relationship is found true in step 338, then storage management processing engine 105 may admit the returning viewer to its I/O task pool in a manner similar to that as described in relation to FIG. 3A, i.e., as shown in steps 360 or 380, after determining in step 350 whether the existing cycle time T and read-ahead size Nᵢ need to be modified in step 370 to take into account the returning viewer. While the value of Reserved_Factor may be reduced in step 334 in an attempt to admit a viewer/s returning from cached state, in one exemplary embodiment the original value of Reserved_Factor is not changed and is still used for admission control when accepting a new viewer/s.

In the practice of the disclosed methods and systems, cycle time T may be any value selected from between the determined lower and upper bounds of a selected Resource Model Equation, such as Resource Model Equation (18). However, in those situations when an information management system is lightly loaded, there may be a big gap between the upper bound and the lower bound, meaning that there is a large range from which a particular value of cycle time T may be selected. If the value of T is selected to be too high within the range, then it is possible that exhaustion of the buffer space may occur while there is still excess I/O capacity remaining. Conversely, if the value of T is selected to be too small within the range, then it is possible that exhaustion of I/O capacity may occur while there is still excess buffer space remaining. In either case, an unbalanced resource utilization may result that requires re-determination of the cycle time T value, and a resulting modification of the read-ahead size based on the new cycle time T. To address this concern, one exemplary embodiment may optimize system performance by using an admission control policy that selects a value of cycle time T in a manner that helps ensure substantially balanced utilization of pre-allocated I/O resource and buffer space by, for example, increasing or maximizing the elapsed time during which introduction of new viewers will not force the redefinition of cycle time T. This may be done in any suitable manner, for example, based on empirically derived information. To illustrate, if a maximal cycle time T value is empirically determined to be about 25 seconds, run time selection of cycle time T value may be determined based on the following relationship:

T=min(lower_{—}bound+20, (lower_{—}bound+upper_{—}bound)/2) (20)

Although FIGS. 3A and 3B illustrate exemplary embodiments of deterministic resource management having an existing cycle time T and read-ahead size Nᵢ that are modified as necessary to support new or returning viewers, it will be understood that a variety of other embodiments using different methodology for resource management are also possible using the disclosed methods and systems. Such embodiments may be based at least in part on the methodology described in FIGS. 3A and or 3B, and/or described elsewhere herein. For example, resource management may be accomplished by determining or modifying only cycle time T or only read-ahead size Nᵢ. Furthermore, it is not necessary that admission control decisions be made in conjunction with such determinations or modifications. Alternatively, it is possible that admission control decisions may be made without any determination or modification of information management system I/O operational parameters. In yet other embodiments, initial values of information management system I/O operational parameters such as cycle time T and/or read-ahead size Nᵢ may be determined in addition to, or as an alternative to, later modification of such information management system I/O operational parameters.

In yet other embodiments, cycle time may modified or limited based on a number of factors. For example cycle time may be limited or capped by limiting read-ahead buffer size, for example, using Resource Model Equations (17B), (18B) or (19B). Cycle time may also be limited or capped by placing a set limit on the maximal buffer size (e.g., by placing a 2MB limit on the maximal buffer size in a case where system throughput does not increase, or does not increase significantly, with any increase in the buffer size beyond 2MB).

### Monitoring of System I/O Performance Characteristics

In the practice of the disclosed methods and systems, monitored system I/O performance characteristics may be at least partially considered or employed to effect information management system I/O resource management actions, for example, by using a resource model embodiment such as described elsewhere herein.

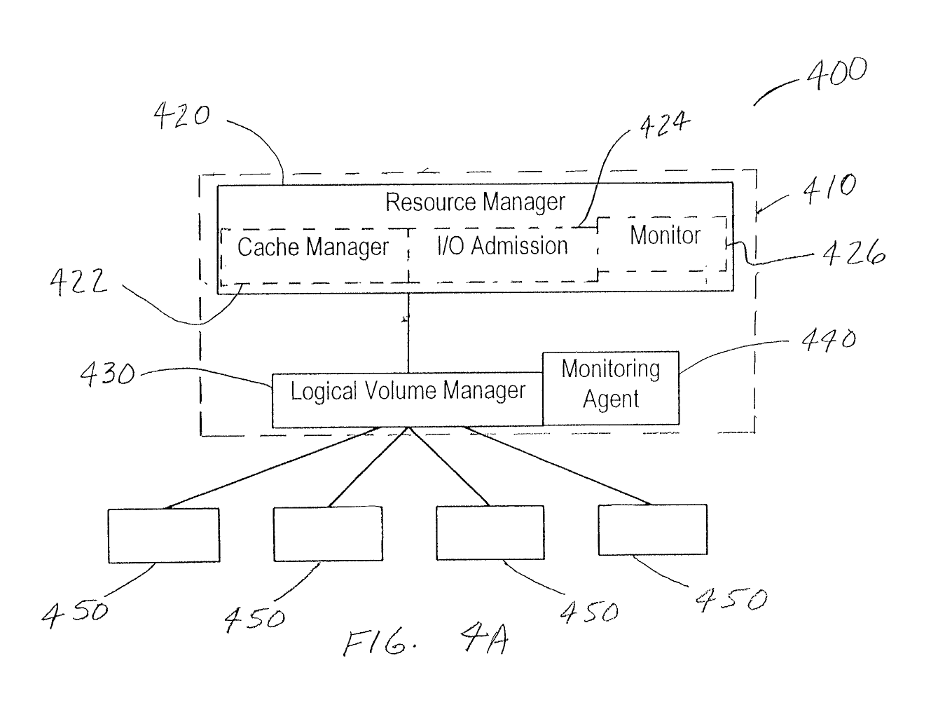

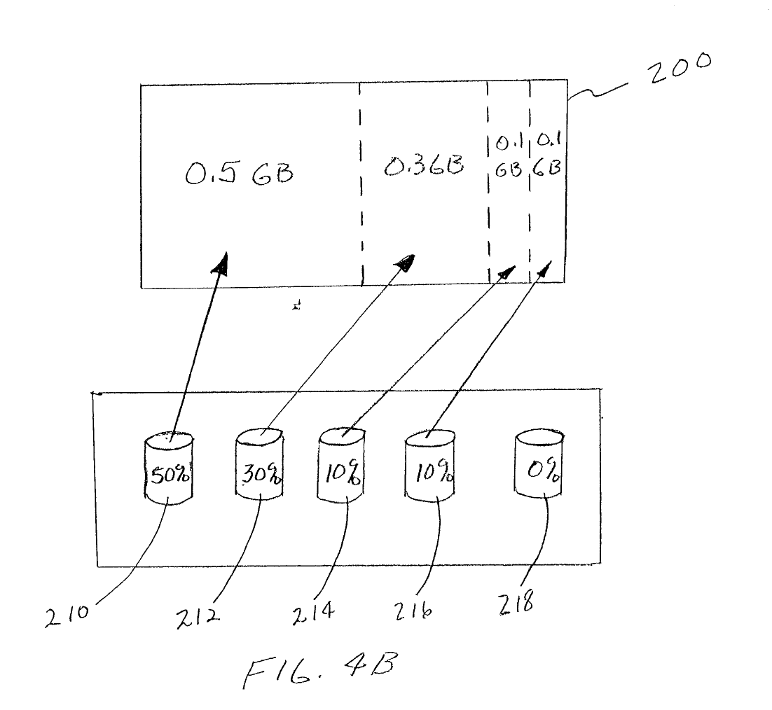

FIG. 4A illustrates one embodiment of a storage system 400 having a storage management processing engine 410 (e.g., storage processor) that includes resource manager 420, logical volume manager 430 and monitoring agent 440. In this embodiment, resource manager 420 is responsible for cache memory management, I/O admission control and resource monitoring and may therefore include cache memory manager 422, I/O admission controller 424 and storage system workload monitor 426. Storage management processing engine 410 may include any hardware configuration e.g., configuration of one or more processors or processing modules, that is capable of performing monitoring, resource modeling, resource management, and/or storage management duties described herein.

As shown in FIG. 4A, storage devices 450 may be coupled to storage management processing engine 410 by way of, for example, fiber channel loop or other suitable method. It will be understood that each storage device 450 may be a single storage device (e.g., single disk drive) or a group of storage devices (e.g., partitioned group of disk drives), and that combinations of single storage devices and storage device groups may be coupled to storage management processing engine 410. In one embodiment, storage management processing engine 410 may include one or more Motorola POWER PC-based processor modules. In the embodiment of FIG. 4A, it will be understood that storage devices 450 (e.g., disk drives) may be controlled at the disk level by storage management processing engine 410, and/or may be optionally partitioned into multiple sub-device layers (e.g., sub-disks) that are controlled by single storage processing engine 410.

Examples of these and other suitable storage management processing engine configurations, as well as examples of information management system environments in which storage management processing engines may be implemented in the practice of the disclosed methods and systems include, but are not limited to, those described in co-pending U.S. patent application Ser. No. 09/797,413 filed on Mar. 1, 2001 which is entitled NETWORK CONNECTED COMPUTING SYSTEM; in co-pending U.S. patent application Ser. No. 09/797,200 filed on Mar. 1, 2001 which is entitled SYSTEMS AND METHODS FOR THE DETERMINISTIC MANAGEMENT OF INFORMATION; and in co-pending U.S. patent application Ser. No. 09/879,810 filed on Jun. 12, 2001 which is entitled SYSTEMS AND METHODS FOR PROVIDING DIFFERENTIATED SERVICE IN INFORMATION MANAGEMENT ENVIRONMENTS; each of the foregoing applications being incorporated herein by reference. Other examples include, but are not limited to, in an external RAID controller configuration, etc.

In the embodiment of FIG. 4A, workload on each storage device 450 may be logically monitored in a collaborative manner between resource manager 420 and logical volume manager 430 using, for example, workload monitor 426 and monitoring agent 440. In this regard, monitoring agent 440 may be employed to track the outstanding I/O requests in each storage device, and workload monitor 426 of resource manager 420 may be employed to track the number of viewers and the aggregated playback rates for each logical volume. In this embodiment, resource manager 420 has the knowledge of the number of plex (i.e., number of portions of a logical volume per storage device) in each logical volume, and therefore the total number of viewers and the aggregated playback rates on each logical volume may be averaged across plex to obtain the estimation of the total number of viewers and the aggregated playback rates on each plex. Thus, workloads may be logically monitored or tracked above the logical volume manager level in terms of number of streams and aggregated playback rates. Advantageously, the disclosed methods and system may be implemented to monitor resource utilization and workload distribution at the logical volume level rather than the physical disk level. For example a combination of logical volume workload, the logical volume level topology, and the number of outstanding I/O commands on each logical subdisk may be used to estimate workload characteristics at the physical disk level.

If, in a particular logical volume, there is only one storage device 450 (e.g., disk drive) per plex, then workload monitor 426 of resource manager 420 may have knowledge of workloads on each individual disk drive without assistance from monitoring agent 440. For example, this is the case as described herein in Examples 7, 9 and 10, where the storage organization may be one disk drive worth of content with several mirrors. However, if there is more than one storage device 450 (e.g., disk drive) per plex, then the workload in the plex level may be refined to obtain the workload view at the disk drive level. For example, this is the case as described herein in Examples 8 and 11, where the storage organization may be multiple disk drives worth of content with several mirrors.

In this latter case, monitoring agent 440 may be used to monitor or keep track of the maximal outstanding I/O for every disk drive and/or sub-disk in the current polling window, for example, using a re-settable outstanding I/O counter or other suitable tracking method. Workload monitor 426 in resource manager 420 may track the total number of viewers and the aggregated playback rate per plex, and may request or poll monitoring agent 440 for number of maximal outstanding I/O for each disk drive and/or sub-disk in a given desired time window, e.g., every 10 seconds, every 2 minutes, etc. Upon receipt of such a request or poll from workload monitor 426, monitoring agent 440 may respond with the requested information, e.g., by sending a disk/subdisk identifier and a respective maximal outstanding I/O for each disk drive and/or sub-disk to the requesting workload monitor 426 of resource manager 420. Monitoring agent 440 may then reset the outstanding I/O counter for the next polling window and start tracking the new value for the next window. For each window, workload monitor 426 may use the number of outstanding I/O per-disk in each plex to estimate the weight of workload distribution into each disk drive and then break down the total number of viewers and the aggregated playback rate on the plex level into the disk level based on the estimated weight of workload distribution per disk drive.

It will be understood that workload monitor 426 and monitoring agent 440 may be implemented in a storage management processing engine using any hardware and/or logical configuration that is capable of performing the described functionalities of same, e.g. the set of tasks specified by monitoring agent 440 to be implemented by logical volume manager 430, and the set of tasks specified by workload monitor 426 to be implemented by resource manager 420. In one exemplary embodiment, monitoring agent 440 and workload monitor 426 may share the same processor space and monitoring agent 440 may keep track of the required information and store it in a table accessible by workload monitor 426 on an as-needed basis.

In either of the above two scenarios, workload monitor 426 of FIG. 4A may report the maximal total viewers per disk drive (MaxNoV_perDisk), and the maximal aggregated playback rate per disk drive (MaxAggRate_perDisk) to I/O admission controller 424. I/O admission controller 424 may employ a resource model equation or algorithm such as previously described herein. In one exemplary embodiment, I/O admission controller 424 may employ Resource Model Equation (19):

$$MaxNoV\_perDisk * AA / [ 1 - Reserved\_Factor - MaxAggRate\_perDisk / TR ] \leq T \leq ( 1 - Reserved\_Factor ) * {B}_{max} / \{ Buffer\_Multiplcity * [ ( 1 - B\_Save ) * ( {\sum }_{i = 1}^{Nov} {P}_{i} ) ] \} \qquad ( 19 )$$

In a further exemplary embodiment, workload monitor 426 may be employed to track the following system I/O performance characteristics for each logical volume, for each plex within a logical volume, and for each disk drive within a plex: (1) total number of viewers (“TotalNov”) on a resource (a logical volume, or a plex, or a disk drive), (2) aggregated playback rate (“TotalRate”) on a resource (a logical volume, or a plex, or a disk drive), (3) current weight (“CurrentWeight”) of workload on a disk drive in a plex, and (4) weight of workload on a disk drive (“NewWeight”) based on the latest poll of the outstanding I/O for each disk drive. In this embodiment, Current Weight is initialized to zero and is continuously updated during the course of monitoring. In this embodiment, a configurable parameter α (“Aging_Factor”) may also be employed to update CurrentWeight after a value of NewWeight is obtained from the latest polling window. If desired, the parameter Aging_Factor may be set to a default value, e.g. from about 0.6 to about 0.7.

In this exemplary embodiment, workload monitor 426 may track TotalNov and TotalRate per logical volume, for example, in a manner as previously described. Workload monitor 426 may obtain an estimation of TotalNov and TotalRate per plex by considering the number of plex (“number_of plex”), for example, as follows:

TotalNov_{—}perPlex=TotalNov_{—}perLV/number_of_plex (21)

TotalRate_{—}perPlex=Totalrate_{—}perLV/number_{—}of_{—}plex (22)

Workload monitor 426 may obtain an estimation of TotalNov and TotalRate per disk drive by polling monitoring agent 440 in a manner as previously to find out how the workload is distributed at the disk drive level. Workload monitor 426 may also poll (or access) monitoring agent 440 at the end of each polling window to obtain the maximal outstanding I/O per subdisk in each plex, denoted by “QueueDepth(i)” where i stands for subdisk ID. Workload monitor 426 may then calculate “NewWeight” per subdisk as follows:

NewWeight(i)=QueueDepth(i)/(Summation of QueueDepth(j) for all subdisk j in the plex) (23)

To help overcome transient effects and stabilize value of workload weight, the workload monitor 426 may then use the following formula and Aging_Factor α (e.g., default value of about 0.6 to about 0.7) to update “CurrentWeight” per disk drive as follows:

CurrentWeight(i)=α*CurrentWeight(i)+(1−α)*NewWeight(i) (24)

Workload monitor 426 may use the following formulas to calculate total number of viewers per subdisk, and total rate per subdisk:

TotalNov_{—}subdisk(i)=TotalNov_{—}perPlex*CurrentWeight(i) (25)

TotalRate_{—}subdisk(i)=TotalRate_{—}perPlex*CurrentWeight(i) (26)

Next, workload monitor 426 may aggregate the subdisk level workload (e.g. total number of viewers per subdisk and total rate per subdisk) into a physical disk level workload (e.g., total number of viewers per disk “TotalNov_disk”, and total rate per disk “TotalRate_disk”):

TotalNov_{—}disk(i)=Sum of TotalNov_{—}subdisk(j) for all subdisk j in disk i (27)

TotalRate_{—}disk(i)=Sum of TotalRate_{—}subdisk(j) for all subdisk j in disk i (28)

Finally, the workload monitor shall update the following parameters for use by admission controller 424, for example, using an I/O admission control algorithm that includes a resource model such as Resource Model Equation (19):

MaxNoV_{—}perDisk=max{TotalNov(i), for all disk drive i} (29)

MaxAggRate_{—}perDisk=max{TotalRate(i), for all disk drive i} (30A)

Although equations of the previously described embodiment may be implemented in a storage environment employing sub-disk partitioning, it will be understood that in other embodiments the sub-disk layer may be disabled if so desired so that a partition of storage devices (e.g., physical disk drive) into sub-disks is not allowed.

### Multiple Storage Device Buffer Allocation in Substantially-unbalanced Workload Environments

To further address unbalanced workload distribution, an optional multiple device buffer allocation scheme may be employed in one embodiment to help optimize buffer space utilization. FIG. 4B shows maximal available buffer memory space (“Bₘₐₓ”) 200, and multiple storage devices 210, 212, 214, 216 and 218 that may be, for example, individual disk drives. In this example, Bₘₐₓ is 1.0 GB. Workload weight per storage device is also shown in FIG. 4B and is expressed as a percentage of total workload, i.e., 50% for device 210, 30% for device 212, 10% for each of respective devices 214 and 216, and 0% for device 218. In this regard workload weight for each storage device may be calculated or estimated using any suitable method such as, for example, by using “CurrentWeight” formula (24) previously given:

CurrentWeight(i)=α*CurrentWeight(i)+(1−α)*NewWeight(i) (24)

Once workload weight for each storage device has been calculated or estimated, buffer memory space 200 may be logically or soft-partitioned into individual buffer memory spaces B(i) assigned to each storage device or group of storage devices (e.g., logical volume group, tenant group, CoS group, etc.) (i) (e.g., 210, 212, 214, 216 and 218). In this regard, a portion of maximal available buffer memory space Bₘₐₓ may be allocated to a respective storage device (i) in a manner that is at least partially dependent on the value of workload weight determined for that storage device, either proportional to value of workload weight for that device, or non-proportional but dependent on the value of workload weight for that storage device. For proportional allocation, the following formula may be employed to calculate:

B(i)=Bₘₐₓ*CurrentWeight(i) (30B)

Thus, as shown in FIG. 4B, storage device 210 is allocated 50% of Bₘₐₓ (0.5 GB), storage device 212 is allocated 30% of Bₘₐₓ (0.3 GB), storage device 214 is allocated 10% of Bₘₐₓ (0.1 GB), storage device 216 is allocated 10% of Bₘₐₓ (0.1 GB), and storage device 218 is not allocated any of Bₘₐₓ.

Following allocation of buffer memory space, total number of viewers per storage device (“TotalNov_disk(i)”), and total rate per storage device (“TotalRate_disk(i)”) may be calculated using equations (27) and (28) previously given:

TotalNov_{—}disk(i)=Sum of TotalNov_{—}subdisk(j) for all subdisk j in disk i (27)

TotalRate_{—}disk(i)=Sum of TotalRate_{—}subdisk(j) for all subdisk j in disk i (28)

Once values of TotalNov_disk(i) and TotalRate_disk(i) have been calculated above, values of cycle time T(i) for each storage device (i) may be calculated in a manner described for other Resource Model Equations given herein, for example, using the upper bound(i) and lower bound(i) based on the following Resource Model Equation (30C), that is similar to Resource Model Equation (13):

$$TotalNov\_disk ( i ) * AA / [ 1 - Reserved\_Factor - ( TotalRate\_disk ( i ) ) / TR ] \leq T ( i ) \leq ( 1 - Reserved\_Factor ) * {B}_{i} / \{ Buffer\_Mulitiplcity * TotalRate\_disk ( i ) ] \} \qquad ( 30 C )$$

Read-ahead size(i) for each storage device (i) may then be calculated, for example, using the calculated value of T(i), block size BL, and play rate or data consumption rate Pᵢ, using the following relationship:

Read-ahead size(i)=[T(i)*Pᵢ]/BL (30D)

### Validation of System I/O Performance Characteristics

Although information management system I/O performance characteristic values may be assumed for each storage device and/or assumed constant for all storage devices (e.g., all disk drives in a multiple disk drive implementation) installed or coupled to a storage processing engine, one embodiment of the disclosed methods and systems may be implemented to perform optional validation of assumed system I/O performance characteristics. Examples of assumed system I/O performance characteristics that may be optionally validated include, but are not limited to, estimated values of seek and rotation latency (e.g., average access time AA), and/or estimated transfer rate (e.g., TR). Optional validation of assumed system I/O performance characteristics may be advantageously employed to optimize information management system I/O performance when assumed performance characteristics are inaccurate. Such may be the case, for example, when assumed values of system I/O performance characteristics are entered wrong, when one or more wrong disk drives are coupled to a system by operational personnel., when an upgrade for disk drives is performed but the configuration table was not updated, when assumed performance characteristics supplied by disk manufacturer are incorrect, etc.

In one embodiment, validation of assumed system I/O performance characteristics such as average access time and transfer rate may be implemented before a storage device (e.g., disk drive) is put into service, for example, by reserving a portion of the processing window for running a utility in the storage management processing engine that performs the validation every time the information management system is booted. Such a storage device performance validation may be implemented using an algorithm or routine. For example, in an information management system employing one or more disk drives, a disk drive performance validation may be conducted on each individual disk drive before the disk drive is ready to be put in service, and may employ random disk sector sequences to measure how many IOPS/second maybe achieved for several different standard block sizes (e.g., at least two block sizes from about 64 kb to about 1 Mb). It will be understood however, that a disk drive performance validation may be conducted using only one tested block size.

In one exemplary embodiment, a disk drive may be substantially fully loaded by using a sequence of random read requests (e.g. about 1000 random read requests) that may be generated at the currently-used block size (e.g., a block size of about 64 KB). The total measured service time (“T1”), ie., the time between submittal of the first read request to the time when all of the read requests are completed by the disk, is measured and recorded. The measured total service time T1 may then be compared to an estimated value of total service time (“Te”) that may be determined using, for example, the assumed average access time AA and the assumed average transfer rate TR (as well as the total number of I/O's and the block size) in a manner as follows.

It will be understood that any suitable single or multiple criteria may be employed to measure or otherwise characterize validation or level/s of validation based on a comparison of one or more measured system I/O performance characteristics with assumed or estimated system I/O performance characteristics. Further, information concerning validation of system I/O performance characteristics may be reported or otherwise communicated (e.g., via alarm or other report format to operational personnel and/or to another processing engine functionality or other equipment) in real time, or may be recorded or otherwise stored or saved in memory on a historical basis for future retrieval or review.

In one exemplary embodiment, a multiple-level validation scheme may be implemented to characterize error or discrepancy between respective measured and assumed/estimated information management system I/O performance characteristic values, and to generate an alarm reflective of the error/discrepancy. For example, a three-level service time comparison and alarm scheme may be implemented as follows: 1) if the error between measured value of total service time (“T1”) and estimated value of total service time (“Te”) is within about 2% of the estimated total service time Te, then the validation may be characterized as passed; 2) if the error is from about 2% to about 7% of the estimated total service time Te, then a yellow alarm may be generated; and if the error is larger than 7% of the estimated total service time Te, then a red alarm may be generated.

In the above-described embodiment, the estimated total service time Te for a disk to complete 1000 read requests of 64 KB may be calculated using the formula:

Te=(1000*AA)+(1000*64/TR) (31)

where AA is in units of milliseconds (“ms”) and TR is in units of KB per milliseconds.

Once Te has been calculated as described above, comparison of the measured service time T1 and the estimated service time Te may then be used to validate the assumed average access time and assumed transfer rate performance characteristics in the three-level manner described above. This may be accomplished, for example, by comparing the absolute value of the difference between Te and T1, to the product of Te and one or more specified gating factors in a manner as follows:

If |T1−Te|≦0.02*Te, then the validation is passed.

If 0.02*Te<|T1−Te|≦0.07*Te, then a yellow alarm is generated.

If |T1−Te|>0.07*Te, then a red alarm is generated.

In the above example, the values of the above gating numbers (i.e., 0.02 and 0.07) are exemplary only, and it will be understood that other values may be selected based on the requirements of a given situation. Further, it is possible to employ a fewer number or greater number of gating values (i.e., to generate greater or fewer validation levels) as so desired. In addition, it will be understood that the above equations given for comparison of estimated and measured values of total service time are exemplary only, and that any other equation/s or other relationships may be employed to compare, validate and/or otherwise characterize estimated/assumed system I/O performance characteristics with measured system I/O performance characteristics.

In a further exemplary embodiment, a storage processing engine may also conduct one or more additional disk performance measurement operations before triggering an information management system I/O performance characteristic alarm. Results of such additional performance measurement operations may be compared or otherwise considered together to determine or estimate a new or corrected value of one or more of the system I/O performance characteristics. For example, in the example given above an additional sequence of the same number of random I/O's as originally employed (e.g., about 1000 I/O's) may be generated at a designated fraction (e.g., half) of the currently employed block size (e.g. at about 32 KB) to again fully load the disk drive. The total service time (i.e., the time between submittal of the first read request to the time when all of the read requests are completed) may be again measured and recorded as an additional or second value of measured total service time (“T2”) in a manner similar to the first value of measured of total service time T1 obtained at the fill block size. The original and additional measured service times made using different block sizes may then be used to make an estimation of the correct average access time AA, and the correct transfer rate, which may be additionally reported by the system when reporting an alarm (e.g., yellow and/or red alarms described above). In one embodiment, estimation of the correct average access time (“AA′”), and the correct transfer rate (“TR′”) may be made by solving Equation 31 for these two unknowns using the two values of measured service time, T1 and T2, that were previously obtained above:

TR′=1000*32/(T1−T2) (32)

AA′=(2*T2−T1)/1000 (33)

Although it is possible that the above estimated values of average access time AA′ and average transfer rate TR′ may be directly used to update stored values of AA and TR within a storage system processing engine (e.g., storage system processor), it may be desirable to only use these values as a reference to assist troubleshooting, e.g., by a system administrator or by automated troubleshooting routines within a storage management processing engine or other processing engine. It is also possible that estimated values of average access time AA′ and average transfer rate TR′ may be saved in meta data block format on the disk so that a record is maintained of the last test period, preventing re-testing of the disk at each re-boot and therefore saving re-boot time. Further, it will be understood that the above 32 KB and 64 KB block size values are exemplary only, and that pairs of block sizes using one of these or using entirely different values (e.g., 64 KB and 128 KB, 32 KB and 128 KB, 64 KB and 512 KB, etc.) may be set or selected as desired to solve equation 31 for two unknowns in the manner given above.

### EXAMPLES

The following examples are illustrative and should not be construed as limiting the scope of the invention or claims thereof.

### Examples 1-6

The following examples present data obtained from one embodiment of a simple resource model according to the disclosed methods and systems. For these examples, it is assumed that total available memory is allocated for buffering and no cache is supported. These examples consider only storage processor capacity for video data retrieving and do not take into account any front-end bandwidth constraints.

Table 1 summarizes various assumptions and setting used in each of examples 1-6. For all examples it is assumed that NoD=5 disk drives with 10,000 RPM capacity. Values of AA and TR performance characteristic data was obtained for a “SEAGATE X10” disk drive by I/O meter testing. A Skew distribution of 1.1 is assumed with no buffer sharing (e.g., B_Save=0), and 10% of the cycle T is reserved for other disk access activities (Reserved_Factor=0.1). Calculations were made for three different playback rates: Pᵢ=20 kbps, Pᵢ=500 kbps and Pᵢ=1 mbps, and for two different buffer space sizes: Bₘₐₓ=1 Gbyte and Bₘₐₓ=1.5 Gbyte. Double buffering is assumed, and thus the value of Buffer_Multiplcity=2.

TABLE 1
Assumptions and Settings

| Exam. | P | B | | AA | TR | | | | | T Max | NoV |
|---|---|---|---|---|---|---|---|---|---|---|---|
| No. | (kbps) | (Gbyte) | Buf_Mult | (ms) | (kBps) | NoD | Skew | Reserved_Factor | B_Save | (Sec) | Max |
| 1 | 20 | 1 | 2 | 8.6 | 23364.85 | 5 | 1.1 | 0.1 | 0 | 22.54 | 8373 |
| 2 | 20 | 1.5 | 2 | 8.6 | 23364.85 | 5 | 1.1 | 0.1 | 0 | 28.37 | 9976 |
| 3 | 500 | 1 | 2 | 8.6 | 23364.85 | 5 | 1.1 | 0.1 | 0 | 7.153 | 1055 |
| 4 | 500 | 1.5 | 2 | 8.6 | 23364.85 | 5 | 1.1 | 0.1 | 0 | 9.82 | 1152 |
| 5 | 1024 | 1 | 2 | 8.6 | 23364.85 | 5 | 1.1 | 0.1 | 0 | 6.17 | 595 |
| 6 | 1024 | 1.5 | 2 | 8.6 | 23364.85 | 5 | 1.1 | 0.1 | 0 | 8.67 | 632 |

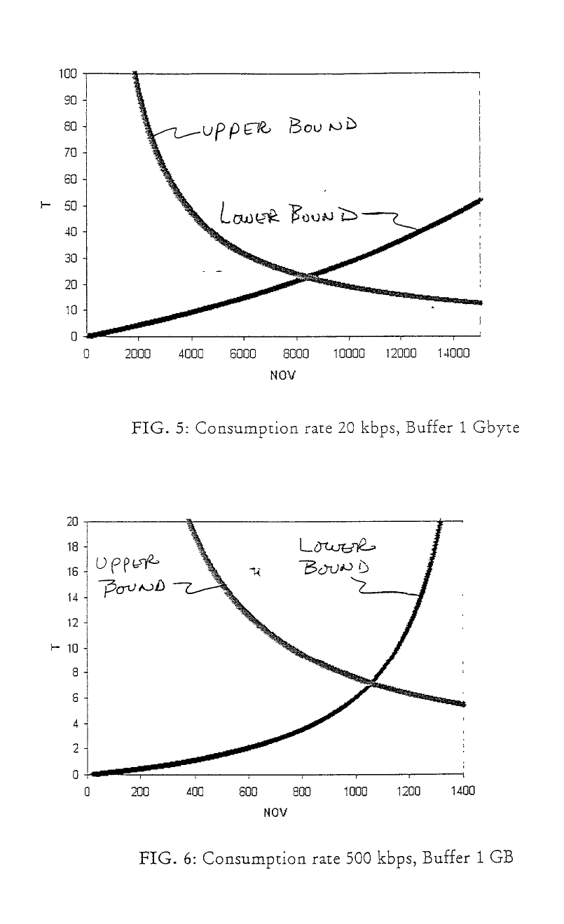

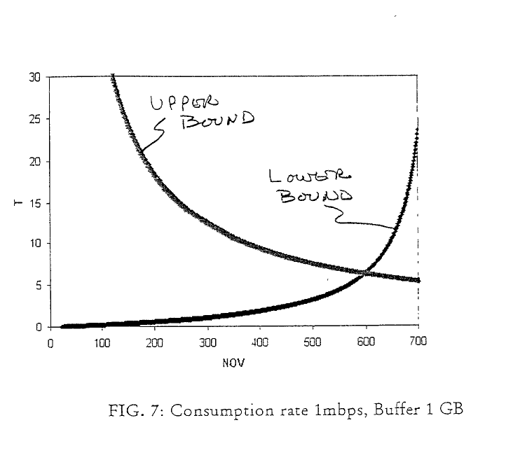

FIGS. 5-7 illustrate lower bounds and upper bounds of cycle time T plotted as a function of NoV for buffer size of 1 Gbyte and each of the three playback rates (i.e., 20 kbps, 500 kbps and 1024 kbps) for Examples 1, 3 and 5 respectively using the following relationships from Resource Model Equation (18):

For lower bound:

T=(Skew/NoD)*NoV*AA/{(1−Reserved_{—}Factor−(Skew/NoD)*(Σᵢ₌₁^{Nov}Pᵢ)/TR]};

For upper bound:

T={(1−Reserved_{—}Factor)*Bₘₐₓ{Buffer_{—}Multiplcity*[(1−B_{—}Save)*(Σᵢ₌₁^{Nov}Pᵢ)]};.

As may be seen from each plot of FIGS. 5-7, it is possible to find where the lower bound curve intercepts the upper bound curve. This interception point may be used to provide two useful values: the maximal number of viewers NoV a storage subsystem may support, and the optimal cycle Time T in which both the I/O capacity and the buffer space are fully utilized. These values are also given in Table 1.

The following observations may be made based on the data of examples 1-6. First, the total system capacity is a balance of several operational characteristics. For example, increasing the buffer space from 1 Gbyte to 1.5 Gbyte (a 50% increment), does not increase the number of viewers the system can support proportionally. Instead, the number of viewers increases by a smaller percentage. Thus, unilaterally increasing buffer space without incrementing I/O capacity, or vice-versa may not achieve optimum system performance. Further, implementing an integrated cache/buffer structure may be more effective to improve system performance than increasing buffer space and/or I/O capacity.

Second, considering front-end bandwidth constraint against the above results, it may be seen that the front-end bandwidth of 500 mbps will reduce the information management system I/O capacity more severely in high client bandwidth cases than in lower client bandwidth cases. For example, where the consumption rate is 20 kbps and the available buffer is 1.5 Gbyte, an information management system can support approximately 10,000 viewers from 5 disk drives, which presents about 197 mbps of front end throughput. On the other hand, where the consumption rate is 1 mbps and the available buffer is 1 Gbyte, then the information management system can support 600 viewers from 5 disk drives, which presents 600 mbps front end throughput, which already exceeds the designated front end bandwidth.

### Examples 7-10

The following hypothetical examples illustrate six exemplary use scenarios that may be implemented utilizing one or more embodiments the disclosed methods and systems.

### Example 7

### Low Bandwidth Video-on-demand Scenario

A relatively low bandwidth access connection (e.g., supporting up to about 56 kbps modem speeds) may be used to offer relatively small continuous data files (e.g., video-on-demand files), such as a two-hour video having a relatively small size of less than about 50 Mbytes). In such a case, a 72 Gbyte size disk drive has the capacity of storing about 3600 two-hour video files at the rate of about 20kbps. However, in one embodiment for supporting 10,000 simultaneous streams, about 5 disk mirrors will be needed to satisfy the required I/O operations. Therefore, one suitable storage configuration for this scenario would be one disk drive worth of content size with several mirrors. This storage configuration may be represented as “(1*72)*n”, which translates to mean “n” number of copies of one 72 GB disk drive.

In the hypothetical scenario of this example, a non-resource monitoring I/O admission control algorithm similar to Resource Model Equation (18) may be suitably employed. In this embodiment, it is not necessary to employ techniques such as load balancing or workload monitoring because mirroring has made them naturally supported. Although resource monitoring techniques (e.g., IOPS monitoring) and dynamic, measurement-based I/O admission control may be implemented as described elsewhere herein, but are also not necessary in this example.

### Example 8

### General High Bandwidth Video-on-demand Scenario

Relatively high bandwidth connections (e.g., newer last mile technologies such as XDSL lines, cable modems, fixed wireless access networks, LAN, optical networks, etc.) may be characterized as having download bandwidths of at least about 128 kbps, on up to several mbps. The higher speed connections of this type are especially suitable for MPEG movies, such as those having a size of from about 1 to about 3 Gbytes.

In the embodiment of this hypothetical example, multiple information management systems (e.g., multiple content delivery systems or content routers) of a type described elsewhere herein may be deployed (e.g., on a rack) to support an aggregated throughput of from about 1000 to about 3000 streams. In this embodiment, only a small percentage of the movie library requires multiple copies, and these may be spread across the multiple information management systems, with each information management system only needing to store at most one copy of the movie library. However, in order to support a couple of thousand movie files, each information management system may be equipped with several disk drives. Such a storage configuration may be represented as “(k*72)*1” which translates to mean “one copy of a “k” number of 72 GB disk drives”.

In the hypothetical scenario of this example, a non-resource monitoring I/O admission control algorithm similar to Resource Model Equation (18) (e.g., a resource model equation that considers number of storage devices NoD and a Skew type factor to estimate workload distribution of each individual disk drive) may be suitable employed where workload is substantially balanced or near balanced. For example, if the total workload is 1000 streams and the number of disk drives is 5, then a perfectly balanced average workload would be 200 streams per disk drive.

However, where workload is substantially unbalanced, a resource-monitoring capable I/O admission control algorithm may be desirable. For example, under conditions where the Skew value is 2, then the maximal workload for each individual drive may be up to 2*200=400 streams. The larger the value of Skew, the greater is the workload unbalance and the smaller the total system throughput. To illustrate an extreme case, if in the system of the current hypothetical example all requests were for the same movie, then because only one disk drive has the requested content, the total number of streams would be limited to the capacity of that single disk drive, while all other drives would be idle. Furthermore, even under scenarios where movie file allocation is planned based on client access pattern (e.g., more multiple disk drive space allocated to copies of “hot” or relatively popular movies), it is still possible that movie popularity may change unexpectedly, such that there still exists the potential that movie requests may suddenly be concentrated on a previously “cold” or relatively unpopular movie and the actual access Skew may exceed that previously estimated or anticipated.

Under such substantially unbalanced workload conditions, workload-monitoring may be advantageously implemented in a storage management processing engine to monitor the run-time actual workload distribution and to adjust the I/O admission control so that it will accept relatively less requests if system workload is more skewed, and will accept relatively more requests if system workload is less skewed. Workload monitoring may be implemented, for example, using resource-monitoring capable I/O admission control algorithms such as described herein in relation to Resource Model Equation (19).

### Example 9

### Internet Streaming Deployment (Lower Bandwidth/Smaller File Size)

Most multimedia objects involved in current Internet streaming applications (e.g., for applications such as music exchange, news-on-demand, embedded commercials, etc.) are relatively short duration clips designed for lower-end bandwidths (e.g., from about 20 kbps to 10 about 300 kbps). The average size of these files is relatively small and, therefore the total file set size directly under the control of a storage processing engine often may fit onto a 72 GB disk drive. One suitable storage organization for this exemplary embodiment would be a configuration similar to that of Example 7, and may be represented as “(1*72)*n”, namely, n mirroring of a 72 GB disk drive.

As with the scenario of Example 7, a non-resource monitoring I/O admission control algorithm similar to Resource Model Equations (18) may be suitably employed for this hypothetical situation. Resource monitoring techniques (e.g., IOPS monitoring) and/or dynamic, measurement-based I/O admission control may be implemented as described elsewhere herein, but are not necessary.

### Example 10

### Internet Streaming Deployment (Higher Bandwidth/Larger File Size)

Capacity improvements in the last mile infrastructure means that the number of relatively high bandwidth-capable (e.g., greater than about 300 kbps) Internet clients will continue to grow. With this trend, an increasing number of bandwidth-intensive multimedia based services will likely be offered. To provide these services, an information management system (e.g., content delivery system, content router) may be deployed under conditions where the majority of clients have high access bandwidth, and where the majority of requested objects is large. Under the conditions of this hypothetical scenario, one suitable storage organization for this exemplary embodiment would be a configuration similar to that of Example 8, i.e., some content may have only one copy and the customer access pattern may impact the system throughput.

As the case with the scenario of Example 8, an I/O admission control algorithm having workload monitoring capability may be advantageously employed under the conditions of this example. Workload monitoring may be implemented, for example, using resource-monitoring capable I/O admission control algorithms such as described herein in relation to Resource Model Equation (19).

For illustration purposes, certain exemplary embodiments described herein relate to use of the disclosed methods and systems in continuous media data delivery embodiments. However, it will be understood with benefit of this disclosure that the disclosed systems and methods may also be advantageously implemented in information delivery environments where data objects of any other kind are managed or delivered. Furthermore, it will be understood that one or more of various possible system components described herein (e.g., resource manager, resource monitor, resource model, cache manager, I/O admission controller, logical volume manager, etc.) and/or tasks performed by such components (e.g., resource monitoring, admission control, read-ahead determination, etc.) and/or combinations of such components, may be implemented logically and/or physically using any software and/or hardware configuration suitable for performance of one or more of such tasks described herein. For example, resource monitoring, resource modeling and/or resource management tasks may be implemented in a separate storage processing engine, and/or may be implemented as part of another I/O subsystem or processing engine of an information management system.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A method of managing I/O resources in an information delivery environment, comprising modeling utilization of at least one of said I/O resources; and managing at least one of said I/O resources based at least in part on said modeled utilization.

2. The method of claim 1, wherein said modeling comprises modeling utilization of at least one of said I/O resources based at least in part on at least one of said system I/O performance characteristics associated with said I/O resources.

3. The method of claim 2, wherein the value of at least one of said system I/O performance characteristics is estimated.

4. The method of claim 2, wherein the value of at least one of said system I/O performance characteristics is monitored.

5. The method of claim 1, wherein said I/O resources comprise at least one of said file system resources, storage system resources, or a combination thereof.

6. The method of claim 1, wherein said information delivery environment comprises delivery of continuous media data from an information management system to a network;
wherein said I/O resources comprise I/O capacity and buffer memory spac e of said in formation management system; and wherein said managing comprises balancing said I/O capacity with said buffer memory space to ensure uninterrupted delivery of said continuous media data.

7. The method of claim 1, wherein said information delivery environment comprises delivery of continuous media data from an information management system to a plurality of viewers across a network; wherein said I/O resources comprise I/O capacity and buffer memory space of said information management system; and wherein said managing comprises balancing said I/O capacity with said buffer memory space to ensure uninterrupted delivery of said continuous media data to said plurality of viewers.

8. The method of claim 7, wherein said information management system comprises a content delivery system that includes a storage system; said content delivery system being coupled to said network; and said storage system including said I/O resources and having at least one storage device or at least one partitioned group of storage devices.

9. The method of claim 8, wherein said managing comprises setting a cycle time of said storage device or partitioned group of storage devices to be greater than or equal to the service time of said storage device or partitioned group of storage devices.

10. The method of claim 9, wherein said managing further comprises setting a cycle time of said storage device storage device or partitioned group of storage devices to maximize the number of simultaneous viewers of said continuous media data that is supported by said information management system.

11. The method of claim 8, wherein said method further comprises allocating at least one of said I/O resources between background system I/O activities and delivery of said continuous media data.

12. The method of claim 11, wherein said at least one of said allocated I/O resources comprise at least one of I/O capacity, buffer space, or a combination thereof.

13. The method of claim 12, wherein said background system I/O activities comprise at least one of said large file write operations, small file access operations, or a combination thereof.

14. The method of claim 13, wherein said method further comprises allocating said at least one I/O resources between said background system I/O activities and delivery of said continuous media data based at least in part on a variable resource parameter.

15. The method of claim 13, wherein said method further comprises dynamically allocating said at least one I/O resources between background system I/O activities and continuous media data delivery based at least in part on monitored background system processing activity.

16. The method of claim 15, wherein said method further comprises dynamically allocating said at least one I/O resources between background system I/O activities and continuous media data delivery in a manner that avoids interruptions in delivery of said continuous media data to existing viewers.

17. The method of claim 15, wherein said method further comprises selecting and terminating delivery of at least one stream of continuous media data to accommodate at least one background system I/O activity; wherein said at least one stream of continuous media data is selected for termination based at least in part on at least one priority-indicative parameter.

18. The method of claim 8, wherein said managing comprises at least one of performing I/O admission control, determining read-ahead size, or a combination thereof.

19. The method of claim 18, wherein said managing comprises performing said I/O admission control by monitoring the number of existing viewers served from said at least one storage device or partitioned group of storage devices and monitoring the data consumption rate of said existing viewers; balancing said I/O capacity with said buffer memory space based at least in part on said monitored number-of existing viewers and said monitored data consumption rates of said existing viewers; and determining whether or not a capacity of said system is sufficient to support at least one additional viewer based at least in part on said balancing of said capacity with said buffer memory space.

20. The method of claim 18, wherein said managing comprises determining said read-ahead size by monitoring the number of existing viewers served from said at least one storage device or partitioned group of storage devices and monitoring the data consumption rate of said existing viewers; balancing said I/O capacity with said buffer memory space based at least in part on said monitored number of existing viewers and said monitored data consumption rates of said existing viewers; setting a cycle time based at least in part on said balancing of said I/O capacity with said buffer memory space; and determining a number of read ahead data blocks based at least in part on said cycle time, said monitored data consumption rate, and a size of said data blocks.

21. The method of claim 18, wherein said managing comprises performing said I/O admission control by monitoring the number of existing viewers served from said at least one storage device or partitioned group of storage devices and monitoring the data consumption rate of said existing viewers; balancing said I/O capacity with said buffer memory space based at least in part on said monitored number of existing viewers and said monitored data consumption rates of said existing viewers; and determining whether or not a capacity of said system is sufficient to support at least one additional viewer based at least in part on said balancing of said I/O capacity with said buffer memory space; and
wherein said managing further comprises determining said read-ahead size by monitoring the number of existing viewers served from said at least one storage device or partitioned group of storage devices and monitoring the data consumption rate of said existing viewers; balancing said I/O capacity with said buffer memory space based at least in part on said monitored number of existing viewers and said monitored data consumption rates of said existing viewers; setting a cycle time based at least in part on said balancing of said I/O capacity with said buffer memory space; and determining a number of read ahead data blocks based at least in part on said cycle time, said monitored data consumption rate, and a size of said data blocks.

22. The method of claim 6, wherein said modeling utilization of at least one of said I/O resources is performed using an analytical-based resource model.

23. The method of claim 6, wherein said modeling utilization of at least one of said I/O resources is performed using a measurement-based resource model.

24. The method of claim 8, wherein said at least one storage device comprises a disk drive or a partitioned group of disk drives; and wherein said modeling comprises modeling utilization of at least one of said I/O resources based at least in part on at least one system I/O performance characteristics associated with said I/O resources, said I/O performance characteristics comprising at least one of seek and rotation latency, estimated transfer rate, or a combination thereof.

25. The method of claim 3, wherein said method further comprises validating an estimated value of at least one of said system I/O performance characteristics by measuring a value of said at least one system I/O performance characteristic, and comparing the measured value of said at least one system I/O performance characteristic to the estimated value of said at least one system I/O performance characteristic.

26. The method of claim 25, wherein said method further comprises reporting an alarm based at least in part on said comparison of the measured value of said at least one system I/O performance characteristic to the estimated value of said at least one system I/O performance characteristic.

27. A method of managing I/O resources for delivery of continuous media data to a plurality of viewers from a storage system including at least one storage device or at least one partitioned group of storage devices, said method comprising modeling utilization of at least one of said I/O resources; and managing at least one of said I/O resources based at least in part on said modeled utilization.

28. The method of claim 27, wherein said storage system comprises a part of a content delivery system coupled to a network; wherein said continuous media data is delivered to said plurality of viewers across said network; and wherein said storage system includes at least two storage devices or at least two partitioned groups of storage devices for delivery of said continuous media data.

29. The method of claim 28, wherein said content delivery system is coupled to said network at an endpoint of said network.

30. The method of claim 28, wherein said I/O resources comprise I/O capacity and buffer memory space of said information management system; wherein said method further comprises modeling said I/O capacity based at least in part on a workload distribution across said at least two storage devices or at least two partitioned groups of storage devices; and wherein said managing comprises balancing said I/O capacity with said buffer memory space to ensure uninterrupted delivery of said continuous media data to said plurality of viewers from said at least two storage devices or said at least two partitioned groups of storage devices.

31. The method of claim 30, further comprising monitoring said workload distribution across said at least two storage devices or at least two partitioned groups of storage devices.

32. The method of claim 30, wherein said managing comprises ensuring that an amount of data consumed by each of said viewers during a cycle time of said storage system is less than or equal to the product of number of data blocks fetched from said at least two storage devices or partitioned groups of storage devices during a service time of said at least two storage devices or partitioned groups of storage devices, and a size of said fetched data blocks.

33. The method of claim 30, wherein said managing comprises ensuring that total available buffer space of said storage system is greater than or equal to the product of number of data blocks fetched from said at least two storage devices or partitioned groups of storage devices during a service time of said at least two storage devices or partitioned groups of storage devices, and a size of said fetched data blocks.

34. The method of claim 30, wherein said managing comprises ensuring that an amount of data consumed by each of said viewers during a cycle time of said storage system is equal to the product of number of data blocks fetched from said at least two storage devices or partitioned groups of storage devices during a service time of said at least two storage devices or partitioned groups of storage devices, and a size of said fetched data blocks; and by ensuring that total available buffer space of said storage system is greater than or equal to the product of number of data blocks fetched from said at least two storage devices or partitioned groups of storage devices during a service time of said at least two storage devices or groups of storage devices, and a size of said fetched data blocks.

35. The method of claim 30, wherein said buffer memory space comprises a part of an integrated cache/buffer memory of said storage system.

36. The method of claim 35, further comprising monitoring a number of viewers that are reading data from said at least two storage devices or partitioned groups of storage devices out of the total number of viewers being served by said storage system; and wherein said managing comprises balancing said I/O capacity with said buffer memory space to ensure uninterrupted delivery of said continuous media data to said viewers reading data from said at least two storage devices or partitioned groups of storage devices.

37. The method of claim 35, wherein said method further comprises limiting a size of said buffer memory space by implementing a read-ahead buffer limit. storage devices.

39. The method of claim 38, wherein said managing further comp rises setting a cycle time of said at least two storage devices or partitioned groups of storage devices to maximize the number of simultaneous viewers of said continuous media data that is supported by said information management system.

40. The method of claim 30, wherein said method further comprises allocating said I/O resources between background processing activities and delivery of said continuous media data.

41. The method of claim 30, wherein said managing comprises at least one of performing I/O admission control, determining read-ahead size, or a combination thereof.

42. The method of claim 41, wherein said managing comprises performing said I/O admission control by monitoring the number of existing viewers served from said at least two storage devices or partitioned groups of storage devices, and monitoring the data consumption rate of said existing viewers; balancing said I/O capacity with said buffer memory space based at least in part on said monitored number of existing viewers and said monitored data consumption rates of said existing viewers; and determining whether or not a capacity of said system is sufficient to support at least one additional viewer based at least in part on said balancing of said I/O capacity with said buffer memory space.

43. The method of claim 41, wherein said managing comprises determining said read-ahead size by monitoring the number of existing viewers served from said at least two storage devices or partitioned groups of storage devices, and monitoring the data consumption rate of said existing viewers; balancing said I/O capacity with said buffer memory space based at least in part on said monitored number of existing viewers and said monitored data consumption rates of said existing viewers; setting a cycle time based at least in part on said balancing of said I/O capacity with said buffer memory space; and determining a number of read ahead data blocks based at least in part on said cycle time, said monitored data consumption rate, and a size of said data blocks.

44. The method of claim 41, wherein said managing comprises performing said I/O admission control by monitoring the number of existing viewers served from said at least two storage devices or partitioned groups of storage devices, and monitoring the data consumption rate of said existing viewers; balancing said I/O capacity with said buffer memory space based at least in part on said monitored number of existing viewers and said monitored data consumption rates of said existing viewers; and determining whether or not a capacity of said system is sufficient to support at least one additional viewer based at least in part on said balancing of said I/O capacity with said buffer memory space; and
wherein said managing further comprises determining said read-ahead size by monitoring the number of existing viewers served from said at least two storage devices or partitioned groups of storage devices, and monitoring the data consumption rate of said existing viewers; balancing said I/O capacity with said buffer memory space based at least in part on said monitored number of existing viewers and said monitored data consumption rates of said existing viewers; setting a cycle time based at least in part on said balancing of said I/O capacity with said buffer memory space; and determining a number of read ahead data blocks based at least in part on said cycle time, said monitored data consumption rate, and a size of said data blocks.

45. The method of claim 30, wherein individual storage devices of said at least two storage devices or partitioned groups of storage devices comprise storage disk drives; and wherein said modeling comprises modeling utilization of at least one of said I/O resources based at least in part on at least one system I/O performance characteristics associated with said I/O resources, said I/O system performance characteristics comprising at least one of seek and rotation latency, estimated transfer rate, or a combination thereof.

46. The method of claim 28, wherein said modeling comprises modeling utilization of at least one of said I/O resources based at least in part on at least one estimated system I/O performance characteristics; and wherein said method further comprises validating an estimated value of at least one of said system I/O performance characteristics by measuring a value of said at least one system I/O performance characteristic, and comparing the measured value of said at least one system I/O performance characteristic to the estimated value of said at least one system I/O performance characteristic.

47. The method of claim 46, wherein said method further comprises reporting an alarm based at least in part on said comparison of the measured value of said at least one system I/O performance characteristic to the estimated value of said at least one system I/O performance characteristic.

48. The method of claim 27, wherein said modeling comprises modeling utilization of at least one of said I/O resources based at least in part on at least one system I/O performance characteristics; wherein said at least one storage device comprises a disk drive and wherein said individual storage devices of said at least one partitioned group of storage devices comprise storage disk drives; and wherein said system I/O performance characteristics comprise at least one of average access time, average transfer rate, number of viewers, estimated consumption rate, sustained transfer rate, combined internal and external transfer rate, average seek time, average rotation delay, average time spent for inter-cylinder moves by a read head, Skew value, or a combination thereof.

49. A method of managing I/O resources in an information delivery environment, comprising performing admission control and determining read-ahead size for a storage system based at least in part on modeled utilization of at least one I/O resources of said storage system.

50. The method of claim 49, wherein said information delivery environment comprises delivery of continuous media data from an information management system to a plurality of viewers across a network; and wherein said I/O resources comprise I/O capacity and buffer memory space of said information management system.

51. The method of claim 50, wherein said information management system comprises a content delivery system that includes a storage system; said content delivery system being coupled to said network; and said storage system including said I/O resources and having at least one storage device or at least one partitioned group of storage devices.

52. The method of claim 51, wherein said performing admission control comprises using said modeled utilization of said I/O resources to determine whether or not said storage system has sufficient I/O capacity and sufficient buffer memory space to support a request for delivery of said continuous media data to a new viewer or an existing viewer returning from a cache state to an I/O state of said storage system, and admitting said viewer to said I/O state of said storage system if said sufficient I/O capacity and said sufficient buffer memory space exist; and wherein said determining read-ahead size comprises re-determining a read-ahead size for each of the existing viewers in said I/O state of said storage system if said new or returning existing viewer is admitted to said I/O state of said storage system, wherein said read-ahead size is determined based at least in part on I/O capacity of said storage system, buffer memory space of said storage system, the total number of existing viewers in said I/O state of storage system, and the data consumption rate of said total number of viewers in said I/O state of said storage system.

53. The method of claim 52, wherein said read-ahead size is determined for each of said existing viewers in said I/O state of said storage system prior to admitting said new viewer or returning existing viewer to said I/O state of said storage system.

54. The method of claim 53, wherein said storage system comprises at least two storage devices or at least two partitioned groups of storage devices.

55. The method of claim 53, wherein said method further comprises monitoring workload and utilization of said at least one storage device or partitioned group of storage devices; and wherein said modeling utilization of said I/O resources is based at least in part on said monitored workload and utilization of said at least one storage device or partitioned group of storage devices.

56. The method of claim 53, wherein said method further comprises allocating said I/O resources between background processing activities and delivery of said continuous media data; and if said storage system has insufficient I/O capacity or insufficient buffer memory space to support a request for delivery of said continuous media data to said new viewer or said existing viewer returning from cache state of said storage system, then re-allocating at least a portion of said I/O resources from said background processing activities to said delivery of said continuous media data and again performing said admission control and said determining read-ahead size based at least in part on said re-allocated I/O resources.

57. The method of claim 51, wherein said storage system has an existing cycle time and an existing read-ahead size, and wherein said method further comprises leaving said existing cycle time and said existing read-ahead size unchanged if no new viewer is admitted to I/O state and no existing viewer is returned from cached state to I/O state; or performing the following steps if an I/O request is received from a new viewer or existing viewer returning from said cached state of said storage system to said I/O state of said storage system:
modeling utilization of at least one I/O resources of said storage system based at least in part on admittance of said new viewer or existing viewer returning from said cached state of said storage system to said I/O state of said storage system;
determining if a possible value or range of possible values of cycle time exist to balance said I/O capacity with said buffer memory space, wherein said I/O capacity is balanced with said buffer memory space based at least in part on said modeled I/O resource utilization;
admitting said new viewer or existing viewer returning from said cached state of said storage system to said I/O state of said storage system if a possible value or range of possible values of cycle time exists to balance said I/O capacity with said buffer memory space;
refusing to admit said new viewer or existing viewer returning from said cached state of said storage system to said I/O state of said storage system if a possible value or range of possible values of cycle time is determined not to exist to balance said I/O capacity with said buffer memory space.

58. The method of claim 57, wherein said method further comprises refusing to admit said new viewer or existing viewer returning from said cached state of said storage system to said I/O state of said storage system if a predetermined range of possible values of cycle time is determined not to exist to balance said I/O capacity with said buffer memory space.

59. The method of claim 57, wherein if a possible value or range of possible values of cycle time exists to balance said I/O capacity with said buffer memory space, then performing one of the following steps prior to admitting said new viewer or existing viewer returning from said cached state of said storage system to said I/O state of said storage system:
leaving the existing value of cycle time and the existing value of read-ahead size unchanged if the existing value of cycle time is equal to said determined possible value of cycle time to balance said I/O capacity with said buffer memory space, or if the existing value of cycle time is within said determined range of possible values of cycle time to balance said I/O capacity with said buffer memory space; or
if the existing value of cycle time is not equal to said possible value of cycle time determined to balance said I/O capacity with said buffer memory space or is not within said range of possible values determined to balance said I/O capacity with said buffer memory space, then determining a new value of cycle time for said storage system that is equal to said determined possible value of cycle time to balance said I/O capacity with said buffer memory space, or that is within said determined range of possible values of cycle time to balance said I/O capacity with said buffer memory space; and determining a new value of read-ahead size for said storage system based at least in part on said new value of cycle time for said storage system.

60. The method of claim 57, wherein prior to refusing to admit said new viewer or existing viewer returning from said cached state of said storage system to said I/O state of said storage system, said method further comprises:
re-allocating at least a portion of said I/O resources from background processing activities to said delivery of said continuous media data;
modeling utilization of at least one I/O resources of said storage system based at least in part on said re-allocated I/O resources and based at least in part on admittance of said new viewer or existing viewer returning from said cached state of said storage system to said I/O state of said storage system;
determining if a possible value or range of possible values of cycle time exist to balance said I/O capacity with said buffer memory space, wherein said I/O capacity is balanced with said buffer memory space based at least in part on said modeled I/O resource utilization based at least in part on said re-allocated I/O resources; and then
admitting said new viewer or existing viewer returning from said cached state of said storage system to said I/O state of said storage system if a possible value or range of possible values of cycle time based at least in part on said re-allocated I/O resources exists to balance said I/O capacity with said buffer memory space; or
refusing to admit said new viewer or existing viewer returning from said cached state of said storage system to said I/O state of said storage system if a possible value or range of possible values of cycle time based at least in part on said re-allocated I/O resources is determined not to exist to balance said I/O capacity with said buffer memory space;

61. The method of claim 60, wherein if a possible value or range of possible values of cycle time based at least in part on said re-allocated I/O resources exists to balance said I/O capacity with said buffer memory space, then performing one of the following steps prior to admitting said new viewer or existing viewer returning from said cached state of said storage system to said I/O state of said storage system:
leaving the existing value of cycle time and the existing value of read-ahead size unchanged if the existing value of cycle time is equal to said determined possible value of cycle time to balance said I/O capacity with said buffer memory space, or if the existing value of cycle time is within said determined range of possible values of cycle time to balance said I/O capacity with said buffer memory space; or
if the existing value of cycle time is not equal to said possible value of cycle time determined to balance said I/O capacity with said buffer memory space or is not within said range of possible values determined to balance said I/O capacity with said buffer memory space, then determining a new value of cycle time for said storage system that is equal to said determined possible value of cycle time to balance said I/O capacity with said buffer memory space, or that is within said determined range of possible values of cycle time to balance said I/O capacity with said buffer memory space; and determining a new value of read-ahead size for said storage system based at least in part on said new value of cycle time for said storage system.

62. The method of claim 57, wherein prior to refusing to admit said existing viewer returning from said cached state of said storage system to said I/O state of said storage system, said method further comprises:
re-allocating at least a portion of said I/O resources from background processing activities to said delivery of said continuous media data;
modeling utilization of at least one I/O resources of said storage system based at least in part on said re-allocated I/O resources and based at least in part on admittance of said existing viewer returning from said cached state of said storage system to said I/O state of said storage system;
determining if a possible value or range of possible values of cycle time exist to balance said I/O capacity with said buffer memory space, wherein said I/O capacity is balanced with said buffer memory space based at least in part on said modeled I/O resource utilization based at least in part on said re-allocated I/O resources; and then
admitting said existing viewer returning from said cached state of said storage system to said I/O state of said storage system if a possible value or range of possible values of cycle time based at least in part on said re-allocated I/O resources exists to balance said I/O capacity with said buffer memory space; or
refusing to admit said existing viewer returning from said cached state of said storage system to said I/O state of said storage system if a possible value or range of possible values of cycle time based at least in part on said re-allocated I/O resources is determined not to exist to balance said I/O capacity with said buffer memory space;

63. The method of claim 62, wherein if a possible value or range of possible values of cycle time based at least in part on said re-allocated I/O resources exists to balance said I/O capacity with said buffer memory space, then performing one of the following steps prior to admitting said existing viewer returning from said cached state of said storage system to said I/O state of said storage system:
leaving the existing value of cycle time and the existing value of read-ahead size unchanged if the existing value of cycle time is equal to said determined possible value of cycle time to balance said I/O capacity with said buffer memory space, or if the existing value of cycle time is within said determined range of possible values of cycle time to balance said I/O capacity with said buffer memory space; or
if the existing value of cycle time is not equal to said possible value of cycle time determined to balance said I/O capacity with said buffer memory space or is not within said range of possible values determined to balance said I/O capacity with said buffer memory space, then determining a new value of cycle time for said storage system that is equal to said determined possible value of cycle time to balance said I/O capacity with said buffer memory space, or that is within said determined range of possible values of cycle time to balance said I/O capacity with said buffer memory space; and determining a new value of read-ahead size for said storage system based at least in part on said new value of cycle time for said storage system.

64. A method of modeling utilization of one or more I/O resources in an information delivery environment, comprising monitoring at least one of said system I/O performance characteristics associated with said I/O resources, and modeling utilization of at least one of said I/O resources based at least in part on said monitored I/O system performance characteristics.

65. The method of claim 64, wherein said information delivery environment comprises delivery of continuous media data to a plurality of viewers from an information management system; and wherein said I/O resources comprise I/O capacity and buffer memory space of said information management system.

66. The method of claim 65, wherein said information management system comprises a storage system, said storage system including said I/O resources and having at least one storage device or at least one partitioned group of storage devices.

67. The method of claim 66, wherein said information management system comprises a content delivery system coupled to a network; and wherein said information delivery environment comprises delivery of continuous media data across said network from said content delivery system to said plurality of viewers.

68. The method of claim 67, wherein said content delivery system comprises an endpoint content delivery system coupled to said network at an endpoint of said network.

69. The method of claim 66, wherein said storage system comprises at least two storage devices or two partitioned groups of storage devices; and wherein said at least one of said monitored system I/O performance characteristics comprise at least one of said system I/O performance characteristics at least partially reflective of workload distribution across said at least two storage devices or said at least two partitioned groups of storage devices.

70. The method of claim 69, wherein said at least one of said monitored system I/O performance characteristics comprise at least one of maximal aggregate consumption rate for each of said at least two storage devices or partitioned groups of storage devices, maximal aggregate number of viewers for each of said at least two storage devices or partitioned groups of storage devices, or a combination thereof.

71. The method of claim 70, wherein said method further comprises managing at least one of said I/O resources for delivery of said continuous media data to said plurality of viewers based at least in part on said modeled utilization.

72. The method of claim 71, wherein an actual value of workload Skew for at least one of said storage devices or at least one of said partitioned groups of storage devices is greater than or equal to about 2.

73. The method of claim 72, wherein said managing comprises balancing said I/O capacity with said buffer memory space to ensure uninterrupted delivery of said continuous media data to said plurality of viewers from said at least two storage devices or said at least two partitioned groups of storage devices.

74. The method of claim 73, wherein said managing comprises setting a cycle time of said two or more storage devices or partitioned groups of storage devices to be greater than or equal to the maximal aggregate service time of said two or more storage devices or partitioned groups of storage devices.

75. The method of claim 74, wherein said managing further comprises setting a cycle time of said two or more storage devices or partitioned groups of storage devices to maximize the number of simultaneous viewers of said continuous media data that is supported by said information management system.

76. The method of claim 71, wherein said method further comprises allocating said I/O resources between background processing activities and delivery of said continuous media data.

77. The method of claim 71, wherein said managing comprises at least one of performing I/O admission control, determining read-ahead size, or a combination thereof.

78. The method of claim 77, wherein said managing comprises performing said I/O admission control by monitoring the number of existing viewers served from said at least one storage device or group of storage devices, and monitoring the data consumption rate of said existing viewers; balancing said I/O capacity with said buffer memory space based at least in part on said monitored number of existing viewers and said monitored data consumption rates of said existing viewers; and determining whether or not a capacity of said system is sufficient to support at least one additional viewer based at least in part on said balancing of said I/O capacity with said buffer memory space.

79. The method of claim 77, wherein said managing comprises determining said read-ahead size by monitoring the number of existing viewers served from said at least one storage device or partitioned group of storage devices, and monitoring the data consumption rate of said existing viewers; balancing said I/O capacity with said buffer memory space based at least in part on said monitored number of existing viewers and said monitored data consumption rates of said existing viewers; setting a cycle time based at least in part on said balancing of said I/O capacity with said buffer memory space; and determining a number of read ahead data blocks based at least in part on said cycle time, said monitored data consumption rate, and a size of said data blocks.

80. The method of claim 77, wherein said managing comprises performing said I/O admission control by monitoring the number of existing viewers served from said at least one storage device or group of storage devices, and monitoring the data consumption rate of said existing viewers; balancing said I/O capacity with said buffer memory space based at least in part on said monitored number of existing viewers and said monitored data consumption rates of said existing viewers; and determining whether or not a capacity of said system is sufficient to support at least one additional viewer based at least in part on said balancing of said I/O capacity with said buffer memory space; and
wherein said managing further comprises determining said read-ahead size by monitoring the number of existing viewers served from said at least one storage device or partitioned group of storage devices, and monitoring the data consumption rate of said existing viewers; balancing said I/O capacity with said buffer memory space based at least in part on said monitored number of existing viewers and said monitored data consumption rates of said existing viewers; setting a cycle time based at least in part on said balancing of said I/O capacity with said buffer memory space; and determining a number of read ahead data blocks based at least in part on said cycle time, said monitored data consumption rate, and a size of said data blocks.

81. The method of claim 71, wherein individual storage devices of said at least two storage devices or partitioned groups of storage devices comprise storage disk drives; and wherein said at least one of said monitored I/O system performance characteristics comprise at least one of seek and rotation latency, estimated transfer rate, or a combination thereof.

82. The method of claim 65, wherein said method further comprises validating an estimated value of at least one of said system I/O performance characteristics by comparing a monitored value of at least one system I/O performance characteristic to the estimated value of said at least one system I/O performance characteristic.

83. The method of claim 82, wherein said method further comprises reporting an alarm based at least in part on said comparison of the monitored value of said at least one system I/O performance characteristic to the estimated value of said at least one system I/O performance characteristic.

84. A method of monitoring I/O resource utilization in an information delivery environment, comprising monitoring said I/O resource utilization at the logical volume level.

85. The method of claim 84, wherein said information delivery environment comprises delivery of continuous media data to a plurality of viewers from an information management system comprising a storage system, said storage system including said I/O resources and having at least one storage device or at least one partitioned group of storage devices.

86. The method of claim 85, wherein said monitoring of said I/O resource utilization comprises monitoring a workload of said at least one storage device or at least one partitioned group of storage devices at the logical volume level.

87. The method of claim 85, wherein said monitoring of said I/O resource utilization comprises monitoring system I/O performance characteristics of said at least one storage device or at least one partitioned group of storage devices at the logical volume level.

88. The method of claim 85, wherein said monitoring of said I/O resource utilization comprises constantly monitoring a workload of said at least one storage device or at least one partitioned group of storage devices at the logical volume level during run-time of said storage system; and wherein said method further comprises deciding to accept or reject at least one new I/O request based at least in part on said monitored workload.

89. The method of claim 85, wherein said method comprises monitoring at least one of maximal aggregate consumption rate for said at least one storage device or partitioned group of storage devices, maximal aggregate number of viewers for said at least one storage device or partitioned group of storage devices, or a combination thereof.

90. The method of claim 84, wherein said information delivery environment comprises delivery of continuous media data to a plurality of viewers from an information management system comprising a storage system, said storage system including said I/O resources and having at least two storage devices or at least two partitioned groups of storage devices.

91. The method of claim 90, wherein said information management system comprises a content delivery system coupled to a network; and wherein said continuous media data is delivered from said content delivery system to said plurality of viewers across said network.

92. The method of claim 91, wherein said content delivery system comprises an endpoint content delivery system coupled to said network at an endpoint of said network.

93. The method of claim 91, further comprising monitoring a workload distribution across said at least two storage devices or at least two partitioned groups of storage devices.

94. The method of claim 93, wherein said workload distribution is monitored by monitoring at least one of maximal aggregate consumption rate for each of said at least two storage devices or partitioned groups of storage devices, maximal aggregate number of viewers for each of said at least two storage devices or partitioned groups of storage devices, or a combination thereof.

95. The method of claim 94, wherein said I/O resources comprise I/O capacity; and wherein said method further comprises modeling said I/O capacity based at least in part on said monitored workload distribution across said at least two storage devices or partitioned groups of storage devices.

96. The method of claim 95, wherein said at least one of said I/O resources further comprise buffer memory space of said information management system; and wherein said method further comprises managing said I/O resources by balancing said I/O capacity with said buffer memory space to ensure uninterrupted delivery of said continuous media data to said plurality of viewers from said at least two storage devices or said at least two partitioned groups of storage devices.

97. The method of claim 96, wherein a maximum actual Skew value of at least one of said storage devices or partitioned groups of storage devices is greater than or equal to about 2.

98. The method of claim 96, wherein said buffer memory space comprises a part of an integrated cache/buffer memory of said storage system.

99. The method of claim 98, wherein said method further comprises limiting a size of said buffer memory space by implementing a read-ahead buffer limit.

100. The method of claim 93, wherein said I/O resources comprise I/O capacity and buffer memory space; and wherein said monitoring of workload distribution comprises monitoring a number of viewers that are reading data from each of said at least two storage devices or partitioned groups of storage devices out of the total number of viewers being served by said storage system; and managing said I/O resources by balancing said I/O capacity with said buffer memory space to ensure uninterrupted delivery of said continuous media data to said viewers reading data from said at least two storage devices or partitioned groups of storage devices.

101. The method of claim 93, wherein said I/O resources comprise I/O capacity and buffer memory space; wherein said monitoring of workload distribution comprises monitoring the number of existing viewers served from each of said at least two storage devices or partitioned groups of storage devices, and monitoring the data consumption rate of said existing viewers; and wherein said method further comprises managing said I/O resources by balancing said I/O capacity with said buffer memory space based at least in part on said monitored number of existing viewers and said monitored data consumption rates of said existing viewers, and determining whether or not a capacity of said system is sufficient to support at least one additional viewer based at least in part on said balancing of said I/O capacity with said buffer memory space.

102. The method of claim 93, wherein said I/O resources comprise I/O capacity and buffer memory space; wherein said monitoring of workload distribution comprises monitoring the number of existing viewers served from each of said at least two storage devices or partitioned groups of storage devices, and monitoring the data consumption rate of said existing viewers; and wherein said method further comprises determining a read-ahead size by balancing said I/O capacity with said buffer memory space based at least in part on said monitored number of existing viewers and said monitored data consumption rates of said existing viewers, setting a cycle time based at least in part on said balancing of said I/O capacity with said buffer memory space; and determining a number of read ahead data blocks based at least in part on said cycle time, said monitored data consumption rate, and a size of said data blocks.

103. The method of claim 93, wherein said I/O resources comprise I/O capacity and buffer memory space; wherein said monitoring of workload distribution comprises monitoring the number of existing viewers served from each of said at least two storage devices or partitioned groups of storage devices, and monitoring the data consumption rate of said existing viewers; and wherein said method furtther comprises managing said I/O resources by balancing said I/O capacity with said buffer memory space based at least in part on said monitored number of existing viewers and said monitored data consumption rates of said existing viewers, and determining whether or not a capacity of said system is sufficient to support at least one additional viewer based at least in part on said balancing of said I/O capacity with said buffer memory space; and wherein said method further comprises determining a read-ahead size by balancing said I/O capacity with said buffer memory space based at least in part on said monitored number of existing viewers and said monitored data consumption rates of said existing viewers, setting a cycle time based at least in part on said balancing of said I/O capacity with said buffer memory space; and determining a number of read ahead data blocks based at least in part on said cycle time, said monitored data consumption rate, and a size of said data blocks.

104. A method of monitoring I/O resource utilization for delivery of information to a plurality of viewers from an information management system including storage system I/O resources and at least one storage device or at least one partitioned group of storage devices; said method comprising logically monitoring workload of said at least one storage device or at least one partitioned group of storage devices.

105. The method of claim 104, wherein said logical monitoring comprises:
monitoring a number of viewers being served by at least one logical volume contained at least in part on said at least one storage device or partitioned group of storage devices, and monitoring the aggregated data consumption rates for said number of viewers being served by at least one logical volume contained at least in part on said at least one storage device or partitioned group of storage devices; and
determining an estimated total number of viewers for said at least one storage device or partitioned group of storage devices, and determining an estimated data consumption rate for said estimated total number of viewers based at least in part on said monitored number of viewers and said monitored aggregated consumption rates for said viewers.

106. The method of claim 104, wherein said delivered information comprises continuous media data, and wherein said storage system includes two or more storage devices or two or more partitioned groups of storage devices for delivery of said continuous media data.

107. The method of claim 106, wherein said information management system comprises a content delivery system coupled to a network; and wherein said continuous media data is delivered from said content delivery system to said plurality of viewers across said network.

108. The method of claim 107, wherein said content delivery system comprises an endpoint content delivery system coupled to said network at an endpoint of said network.

109. The method of claim 107, wherein said logical monitoring comprises:
monitoring a number of viewers being served by at least a portion of each of said at least two storage devices or at least two partitioned groups of storage devices, and monitoring the aggregated data consumption rates for said number of viewers being served by said at least a portion of each of said at least two storage devices or at least two partitioned groups of storage devices;
monitoring a number of outstanding I/O requests for at least a portion of each of said at least two storage devices or at least two partitioned groups of storage devices;
determining an estimated total number of viewers for each of said at least two storage devices based at least in part on said number of viewers being served by at least a portion of each of said at least two storage devices or at least two partitioned groups of storage devices, and said monitored number of outstanding I/O requests for at least a portion of each of said at least two storage devices or at least two partitioned groups of storage devices; and
determining an estimated aggregated data consumption rate for each of said at least two storage devices or at least two partitioned groups of storage devices based at least in part on said estimated aggregated data consumption rate for said number of viewers being served by said at least a portion of each of said at least two storage devices or at least two partitioned groups of storage devices, and said monitored number of outstanding I/O requests for at least a portion of each of said at least two storage devices or at least two partitioned groups of storage devices.

110. The method of claim 109, further comprising:
determining an estimated workload distribution across said at least two storage devices or at least two partitioned groups of storage devices based at least in part on said monitored number of outstanding I/O requests for at least a portion of each of said at least two storage devices or at least two partitioned groups of storage devices;
wherein said estimated total number of viewers for each of said at least two storage devices or at least two partitioned groups of storage devices is determined based at least in part on said estimated total number of viewers being served by at least a portion of each of said at least two storage devices or at least two partitioned groups of storage devices, and said estimated workload distribution for each of said respective at least two storage devices or at least two partitioned groups of storage devices; and
wherein said estimated aggregated data consumption rate for each of said at least two storage devices or at least two partitioned groups of storage devices is determined based at least in part on said estimated aggregated data consumption rate for each of said at least two storage devices or at least two partitioned groups of storage devices, and estimated workload distribution for each of said respective at least two storage devices or at least two partitioned groups of storage devices.

111. The method of claim 107, wherein said logical monitoring comprises:
monitoring a number of viewers being served by each logical volume contained on said at least two storage devices or at least two partitioned groups of storage devices, monitoring the aggregated data consumption rates for said number of viewers being served by each logical volume contained on said at least two storage devices or at least two partitioned groups of storage devices, and monitoring the number of plex for each said logical volume on said at least two storage devices or at least two partitioned groups of storage devices;
monitoring a number of outstanding I/O requests for each said plex;
determining an estimated total number of viewers for each said plex based at least in part on said monitored number of plex for each logical volume and said monitored number of viewers for each logical volume;
determining an estimated aggregated data consumption rate for each said plex based at least in part on said monitored number of plex for each logical volume and said monitored aggregated data consumption rates;
determining an estimated total number of viewers for each of said at least two storage devices or at least two partitioned groups of storage devices based at least in part on said estimated total number of viewers for each said plex and said monitored number of outstanding I/O requests for each said plex; and
determining an estimated aggregated data consumption rate for each of said at least two storage devices or at least two partitioned groups of storage devices based at least in part on said estimated aggregated data consumption rate for each said plex and said monitored number of outstanding I/O requests for each said plex.

112. The method of claim 111, further comprising:
determining a maximal number of outstanding I/O requests for each said plex, and determining an estimated workload distribution across said at least two storage devices or at least two partitioned groups of storage devices based at least in part on said monitored maximal number of outstanding I/O requests for each said plex; and
wherein said estimated total number of viewers for each of said at least two storage devices or at least two partitioned groups of storage devices is determined based at least in part on said estimated total number of viewers for each said plex and said estimated workload distribution for each of said respective at least two storage devices or at least two partitioned groups of storage devices; and
wherein said estimated aggregated data consumption rate for each of said at least two storage devices or at least two partitioned groups of storage devices is determined based at least in part on said estimated aggregated data consumption rate for each said plex and estimated workload distribution for each of said respective at least two storage devices or at least two partitioned groups of storage devices.

113. The method of claim 111, wherein each of said storage devices comprise storage disk drives.

114. The method of claim 107, further comprising determining a maximal total number of viewers per storage device and a maximal aggregated consumption rate storage device or per partitioned group of storage devices.

115. The method of claim 114, wherein said I/O resources comprise I/O capacity; and wherein said method further comprises modeling said I/O capacity based at least in part on said determined maximal total number of viewers per storage device or per partitioned group of storage devices, and said determined maximal aggregated consumption rate per storage device.

116. The method of claim 115, wherein said at least one of said I/O resources further comprise buffer memory space of said information management system; and wherein said method further comprises managing said I/O resources by balancing said I/O capacity with said buffer memory space to ensure uninterrupted delivery of said continuous media data to said plurality of viewers from said at least two storage devices or said at least two partitioned groups of storage devices; wherein said balancing is based at least in part on said determined maximal total number of viewers per storage device or per partitioned group of storage devices, and said determined maximal aggregated consumption rate per storage device or per partitioned group of storage devices.

117. The method of claim 116, wherein method further comprises performing I/O admission control, determining read-ahead size, or a combination thereof; wherein said performance of I/O admission control and determination of read-ahead size are based at least in part on said determined maximal total number of viewers per storage device or per partitioned group of storage devices, and said determined maximal aggregated consumption rate per storage device or per partitioned group of storage devices.

118. The method of claim 117, wherein said method comprises performing I/O admission control by determining whether or not a capacity of said system is sufficient to support at least one additional viewer based at least in part on said balancing of said I/O capacity with said buffer memory space.

119. The method of claim 117, wherein said method comprises determining read-ahead size by setting a cycle time based at least in part on said balancing of said I/O capacity with said buffer memory space; and determining a number of read ahead data blocks based at least in part on said cycle time, determined maximal aggregated consumption rate per storage device or per partitioned group of storage devices, and a size of said data blocks.

120. The method of claim 117, wherein said method comprises performing said I/O admission control by determining whether or not a capacity of said system is sufficient to support at least one additional viewer based at least in part on said balancing of said I/O capacity with said buffer memory space; and wherein said method further comprises determining read-ahead size by setting a cycle time based at least in part on said balancing of said I/O capacity with said buffer memory space; and determining a number of read ahead data blocks based at least in part on said cycle time, determined maximal aggregated consumption rate per storage device or per partitioned group of storage devices, and a size of said data blocks.

121. The method of claim 107, wherein said logical monitoring comprises monitoring the following system I/O performance characteristics for each logical volume, for each plex within a logical volume, and for each storage device or partitioned group of storage devices within a plex: (A) total number of viewers, (B) aggregated data consumption rate, (C) current weight of workload on a storage device in a plex, and (D) number of outstanding I/O requests for each storage device or partitioned group of storage devices.

122. The method of claim 107, wherein said method further comprises determining a workload weight distribution for each of said storage devices or partitioned group of storage devices based at least in part on said monitored number of outstanding I/O requests for each storage device or partitioned group of storage devices.

123. An I/O resource management system capable of managing I/O resources in an information delivery environment, comprising:
an I/O resource model capable of modeling utilization of at least one of said I/O resources; and
an I/O resource manager in communication with said I/O resource model, said I/O resource manager being capable of managing at least one of said I/O resources based at least in part on said modeled utilization.

124. The system of claim 123, wherein said I/O resource model is capable of modeling utilization of at least one of said I/O resources based at least in part on at least one of said system I/O performance characteristics associated with said I/O resources.

125. The system of claim 124, wherein the value of at least one of said system I/O performance characteristics is estimated.

126. The system of claim 124, wherein said I/O resource management system further comprises at least one I/O resource monitor in communication with at least one of said I/O resource manager or said I/O resource model, said I/O resource monitor being capable of monitoring the value of at least one of said system I/O performance characteristics.

127. The system of claim 123, wherein said I/O resources comprise at least one of file system resources, storage system resources, or a combination thereof.

128. The system of claim 123, wherein said information delivery environment comprises delivery of continuous media data from an information management system in communication with said I/O resource management system; wherein said I/O resources comprise I/O capacity and buffer memory space of said information management system; and wherein said I/O resource manager is capable of balancing said I/O capacity with said buffer memory space to ensure uninterrupted delivery of said continuous media data.

129. The system of claim 128, wherein said information management system comprises a storage system, said storage system including said I/O resources and having at least one storage device or at least one partitioned group of storage devices.

130. The system of claim 129, wherein said information delivery environment comprises delivery of continuous media data from said information management system to a network; and wherein said information management system comprises a content delivery system configured to be coupled to a network.

131. The system of claim 130, wherein said content delivery system is configured to be coupled to a network at an endpoint of said network.

132. The system of claim 129, wherein said I/O resource manager is capable of allocating at least one of said I/O resources between background system I/O activities and delivery of said continuous media data.

133. The system of claim 132, wherein said I/O resource management system further comprises at least one I/O resource monitor in communication with at least one of said I/O resource manager or said I/O resource model, said I/O resource monitor being capable of monitoring background system processing activity; and wherein said I/O resource manager is capable of allocating said at least one of said I/O resources between background system I/O activities and delivery of said continuous media data based at least in part on said monitored background system processing activity.

134. The system of claim 129, wherein said I/O resource manager is capable of at least one of performing I/O admission control, determining read-ahead size, or a combination thereof.

135. The system of claim 128, wherein said I/O resource model comprises an analytical-based resource model.

136. The system of claim 128, wherein said I/O resource management system further comprises at least one I/O resource monitor in communication with said I/O resource model; and wherein said I/O resource model comprises a measurement-based resource model.

137. An I/O resource management system capable of managing I/O resources for delivery of continuous media data to a plurality of viewers from a storage system including at least one storage device or at least one partitioned group of storage devices, said system comprising:
an I/O resource monitor, said I/O resource monitor being capable of monitoring at least one of said system I/O performance characteristics associated with said I/O resources;
an I/O resource model in communication with said I/O resource monitor, said resource model being capable of modeling utilization of at least one of said I/O resources based at least in part on said at least one of said monitored system I/O performance characteristics; and
an I/O resource manager in communication with said I/O resource model, said I/O resource manager being capable of managing at least one of said I/O resources based at least in part on said modeled utilization.

138. The system of claim 137, wherein said storage system comprises part of a content delivery system configured to be coupled to a network.

139. The system of claim 138, wherein said content delivery system is configured to be coupled to said network at an endpoint of said network.

140. The system of claim 138, wherein said storage system includes at least two storage devices or at least two partitioned groups of storage devices for delivery of said continuous media data.

141. The system of claim 140, wherein said resource monitor is capable of monitoring a workload distribution across said at least two storage devices or at least two partitioned groups of storage devices; wherein said I/O resources comprise I/O capacity and buffer memory space of said information management system; and wherein said I/O resource model is capable of modeling said I/O capacity based at least in part on a workload distribution across said at least two storage devices or two or more partitioned groups of storage devices; and wherein said resource manager is capable of balancing said I/O capacity with said buffer memory space to ensure uninterrupted delivery of said continuous media data to said plurality of viewers from said at least two storage devices or said at least two partitioned groups of storage devices.

142. The system of claim 141, wherein said buffer memory space comprises a part of an integrated cache/buffer memory of said storage system; wherein said I/O resource monitor is capable of monitoring a number of viewers that are reading data from said two or more storage devices or partitioned groups of storage devices out of the total number of viewers being served by said storage system; and wherein said I/O resource manager is capable of balancing said I/O capacity with said buffer memory space to ensure uninterrupted delivery of said continuous media data to said viewers reading data from said two or more storage devices or partitioned groups of storage devices.

143. The system of claim 141, wherein I/O resource manager is capable of allocating said I/O resources between background processing activities and delivery of said continuous media data.

144. The system of claim 141, wherein I/O resource manager is capable of at least one of performing I/O admission control, determining read-ahead size, or a combination thereof.

145. The system of claim 141, wherein individual storage devices of said at least two storage devices or partitioned groups of storage devices comprise storage disk drives; and wherein said I/O resource model is capable of modeling utilization of at least one of said I/O resources based at least in part on at least one of said monitored system I/O performance characteristics associated with said I/O resources, said I/O system performance characteristics comprising at least one of seek and rotation latency, estimated transfer rate, or a combination thereof.

146. The system of claim 138, wherein said I/O resources comprise I/O capacity and buffer memory space of said storage system.

147. The system of claim 146, wherein said storage system comprises at least two storage devices or two partitioned groups of storage devices; and wherein said at least one of said monitored system I/O performance characteristics comprise at least one of said system I/O performance characteristics at least partially reflective of workload distribution across said at least two storage devices or said at least two partitioned groups of storage devices.

148. The system of claim 147, wherein said at least one of said monitored system I/O performance characteristics comprise at least one of maximal aggregate consumption rate for each of said at least two storage devices or partitioned groups of storage devices, maximal aggregate number of viewers for each of said at least two storage devices or partitioned groups of storage devices, or a combination thereof.

149. The system of claim 148, wherein said resource manager is capable of managing at least one of said I/O resources for delivery of said continuous media data to said plurality of viewers based at least in part on said modeled utilization.

150. The system of claim 149, wherein said resource manager is capable of balancing said I/O capacity with said buffer memory space to ensure uninterrupted delivery of said continuous media data to said plurality of viewers from said at least two storage devices or said at least two partitioned groups of storage devices.

151. The system of claim 149, wherein said I/O resource manager is capable of at least one of performing I/O admission control, determining read-ahead size, or a combination thereof.

152. The system of claim 138, wherein said I/O resource manager is capable of monitoring said at least one of said system I/O performance characteristics at the logical volume level.

153. The system of claim 152, wherein said I/O resource monitor is capable of monitoring said system I/O performance characteristics of said at least one storage device or at least one partitioned group of storage devices at the logical volume level.

154. The system of claim 152, wherein said I/O resource monitor is capable of monitoring at least one of maximal aggregate consumption rate for said at least one storage device or partitioned group of storage devices, maximal aggregate number of viewers for said at least one storage device or partitioned group of storage devices, or a combination thereof.

155. The system of claim 152, wherein said storage system includes at least two storage devices or at least two partitioned groups of storage devices.

156. The system of claim 155, wherein said I/O resource monitor is capable of monitoring a workload distribution across said at least two storage devices or at least two partitioned groups of storage devices.

157. An information delivery storage system, said storage system comprising:
a storage management processing engine that includes an I/O resource manager, a logical volume manager, and a monitoring agent; said I/O resource manager, said logical volume manager, and said monitoring agent being in communication; and
at least one storage device or group of storage devices coupled to said storage management processing engine;
wherein said information delivery storage system comprises part of an information management system configured to be coupled to a network.

158. The system of claim 157, wherein said storage management processing engine comprises at least one of said processing modules that are capable of performing at least one of I/O resource monitoring, I/O resource modeling, I/O resource management, or a combination thereof.

159. The system of claim 158, wherein said I/O resource manager comprises a storage system workload monitor.

160. The system of claim 159, wherein said monitoring agent is capable of monitoring number of outstanding I/O requests in at least one storage device or group of storage devices; and wherein said storage system workload monitor is capable of monitoring a number of viewers being served by at least one logical volume contained at least in part on said at least one storage device or partitioned group of storage devices, and monitoring the aggregated data consumption rates for said number of viewers being served by at least one logical volume contained at least in part on said at least one storage device or partitioned group of storage devices.

161. The system of claim 160, wherein said information management system comprises a content delivery system; wherein delivered information comprises continuous media data; and wherein said storage system includes two or more storage devices or two or more partitioned groups of storage devices for delivery of said continuous media data.

162. The system of claim 161, wherein said monitoring agent is capable of monitoring a number of outstanding I/O requests for at least a portion of each of said at least two storage devices or at least two partitioned groups of storage devices; and wherein said storage system workload monitor is capable of:
monitoring a number of viewers being served by at least a portion of each of said at least two storage devices or at least two partitioned groups of storage devices, and monitoring the aggregated data consumption rates for said number of viewers being served by said at least a portion of each of said at least two storage devices or at least two partitioned groups of storage devices;
determining an estimated total number of viewers for each of said at least two storage devices based at least in part on said number of viewers being served by at least a portion of each of said at least two storage devices or at least two partitioned groups of storage devices, and said monitored number of outstanding I/O requests for at least a portion of each of said at least two storage devices or at least two partitioned groups of storage devices; and
determining an estimated aggregated data consumption rate for each of said at least two storage devices or at least two partitioned groups of storage devices based at least in part on said estimated aggregated data consumption rate for said number of viewers being served by said at least a portion of each of said at least two storage devices or at least two partitioned groups of storage devices, and said monitored number of outstanding I/O requests for at least a portion of each of said at least two storage devices or at least two partitioned groups of storage devices.

163. The system of claim 162, wherein said workload monitor is further capable of:
determining an estimated workload distribution across said at least two storage devices or at least two partitioned groups of storage devices based at least in part on said monitored number of outstanding I/O requests for at least a portion of each of said at least two storage devices or at least two partitioned groups of storage devices;
wherein said estimated total number of viewers for each of said at least two storage devices or at least two partitioned groups of storage devices is determined based at least in part on said estimated total number of viewers being served by at least a portion of each of said at least two storage devices or at least two partitioned groups of storage devices, and said estimated workload distribution for each of said respective at least two storage devices or at least two partitioned groups of storage devices; and
wherein said estimated aggregated data consumption rate for each of said at least two storage devices or at least two partitioned groups of storage devices is determined based at least in part on said estimated aggregated data consumption rate for each of said at least two storage devices or at least two partitioned groups of storage devices, and estimated workload distribution for each of said respective at least two storage devices or at least two partitioned groups of storage devices.

164. The system of claim 161, wherein said I/O resource manager has knowledge of the number of plex for each logical volume contained on said at least two storage devices or at least two partitioned groups of storage devices; wherein said monitoring agent is capable of monitoring a number of outstanding I/O requests for each said plex; and wherein said storage system workload monitor is capable of:
monitoring a number of viewers being served by each logical volume contained on said at least two storage devices or at least two partitioned groups of storage devices, monitoring the aggregated data consumption rates for said number of viewers being served by each logical volume contained on said at least two storage devices or at least two partitioned groups of storage devices;
determining an estimated total number of viewers for each said plex based at least in part on said monitored number of plex for each logical volume and said monitored number of viewers for each logical volume;
determining an estimated aggregated data consumption rate for each said plex based at least in part on said monitored number of plex for each logical volume and said monitored aggregated data consumption rates;
determining an estimated total number of viewers for each of said at least two storage devices or at least two partitioned groups of storage devices based at least in part on said estimated total number of viewers for each said plex and said monitored number of outstanding I/O requests for each said plex; and
determining an estimated aggregated data consumption rate for each of said at least two storage devices or at least two partitioned groups of storage devices based at least in part on said estimated aggregated data consumption rate for each said plex and said monitored number of outstanding I/O requests for each said plex.

165. The system of claim 164, wherein said monitoring agent is further capable of determining a maximal number of outstanding I/O requests for each said plex; and wherein said storage system workload monitor is capable of:
determining an estimated workload distribution across said at least two storage devices or at least two partitioned groups of storage devices based at least in part on said monitored maximal number of outstanding I/O requests for each said plex;
determining an estimated total number of viewers for each of said at least two storage devices or at least two partitioned groups of storage devices based at least in part on said estimated total number of viewers for each said plex and said estimated workload distribution for each of said respective at least two storage devices or at least two partitioned groups of storage devices; and
determining an estimated aggregated data consumption rate for each of said at least two storage devices or at least two partitioned groups of storage devices based at least in part on said estimated aggregated data consumption rate for each said plex and estimated workload distribution for each of said respective at least two storage devices or at least two partitioned groups of storage devices.

166. The system of claim 164, wherein each of said storage devices comprise storage disk drives.

167. The system of claim 162, wherein said storage system workload monitor is capable of determining a maximal total number of viewers per storage device and a maximal aggregated data consumption rate storage device or per partitioned group of storage devices.

168. The system of claim 167, wherein said I/O resources comprise I/O capacity; and wherein said I/O resource manager is capable of modeling said I/O capacity based at least in part on said determined maximal total number of viewers per storage device or per partitioned group of storage devices, and said determined maximal aggregated consumption rate per storage device.

169. The system of claim 168, wherein said at least one of said I/O resources further comprise buffer memory space of said information management system; and wherein said I/O resource manager is capable of managing said I/O resources by balancing said I/O capacity with said buffer memory space to ensure uninterrupted delivery of said continuous media data to said plurality of viewers from said at least two storage devices or said at least two partitioned groups of storage devices; wherein said balancing is based at least in part on said determined maximal total number of viewers per storage device or per partitioned group of storage devices, and said determined maximal aggregated consumption rate per storage device or per partitioned group of storage devices.

170. The system of claim 169, wherein said I/O resource manager is capable of performing I/O admission control, determining read-ahead size, or a combination thereof; wherein said performance of I/O admission control and determination of read-ahead size are based at least in part on said determined maximal total number of viewers per storage device or per partitioned group of storage devices, and said determined maximal aggregated consumption rate per storage device or per partitioned group of storage devices.

171. The system of claim 170, wherein said I/O resource manager is capable of performing I/O admission control by determining whether or not a capacity of said system is sufficient to support at least one additional viewer based at least in part on said balancing of said I/O capacity with said buffer memory space.

172. The system of claim 170, wherein said resource manager is capable of determining read-ahead size by setting a cycle time based at least in part on said balancing of said I/O capacity with said buffer memory space; and determining a number of read ahead data blocks based at least in part on said cycle time, determined maximal aggregated consumption rate per storage device or per partitioned group of storage devices, and a size of said data blocks.

173. The system of claim 170, wherein said resource manager is capable of performing said I/O admission control by determining whether or not a capacity of said system is sufficient to support at least one additional viewer based at least in part on said balancing of said I/O capacity with said buffer memory space; and wherein said method further comprises determining read-ahead size by setting a cycle time based at least in part on said balancing of said I/O capacity with said buffer memory space; and determining a number of read ahead data blocks based at least in part on said cycle time, determined maximal aggregated consumption rate per storage device or per partitioned group of storage devices, and a size of said data blocks.

174. The system of claim 161, wherein said storage system workload monitor is capable of monitoring the following system I/O performance characteristics for each logical volume, for each plex within a logical volume, and for each storage device or partitioned group of storage devices within a plex: (1) total number of viewers, (2) aggregated data consumption rate, (3) current weight of workload on a storage device in a plex, and (4) number of outstanding I/O requests for each storage device or partitioned group of storage devices.

175. The system of claim 161, wherein said storage system workload monitor is capable of determining a workload weight distribution for each of said storage devices or partitioned group of storage devices based at least in part on said monitored number of outstanding I/O requests for each storage device or partitioned group of storage devices.
